(19) United States
(12) Patent Application Publication
(10) Pub. No.: US 2007/0065555 A1
(43) Pub. Date: Mar. 22, 2007

(54) Stabilized edible foams

(75) Inventors: David Soane, Chestnut Hill, MA (US); Michael C. Berg, Somerville, MA (US); William A. Mowers, Lynn, MA (US); Bright Walker, Berkeley, CA (US)

Correspondence Address: GOODWIN PROCTER LLP;PATENT ADMINISTRATOR, EXCHANGE PLACE, BOSTON, MA, 02109-2881, US

(73) Assignee: DuraFizz, LLC, Cambridge, MA (US)

(21) Appl. No.: 11/482,555

(22) Filed: Jul. 7, 2006

Related U.S. Application Data
(60) Provisional application No. 60/697,611, filed on Jul. 8, 2005.

(51) Int. Cl. A23L 1/00

(52) U.S. Cl. 426/564

(57) ABSTRACT

The invention relates to formulations for palatable foams with enhanced stability. In certain embodiments, the formulations include a base liquid (such as milk), a surfactant, a polysaccharide, and a polymer capable of molecular interaction with the polysaccharide. The formulations are versatile and can be adapted to create foams of various fat content, textures, and foam stabilities. The foams can be created with simple aeration systems such as disposable, pressurized canisters, as well as high-speed, bulk dispensation systems that are currently used in high turnover restaurants and convenience stores.

### PRIOR APPLICATIONS

This application claims benefit of U.S. Provisional Patent Application No. 60/697,611, filed Jul. 8, 2005, the text of which is incorporated by reference herein in its entirety.

### FIELD OF THE INVENTION

This invention relates generally to edible foams such as beverage foams and dessert toppings. More particularly, in certain embodiments, the invention relates to formulations of edible foams having enhanced stability.

### BACKGROUND OF THE INVENTION

A stable, high quality, palatable foam is important in many food and beverage applications, for example, in coffee drinks, beer, cider, and as a topping or ingredient in desserts, pastries, and other foodstuffs.

There are a number of mechanical devices for creating foam from milk, air, and/or steam. Mechanically-produced milk foams usually tend to collapse quickly and generally have a poor texture, particularly if the base liquid contains an appreciable amount of fat.

Cappuccino machines can produce a high quality foam by introduction of gas and/or vapor into a volume of vigorously agitated milk. Many products of varying consistency and composition are marketed as “cappuccino,” but cappuccino in its traditional sense is a beverage consisting of a dense, milky, coffee phase topped with a creamy layer of foamed milk, the foamed milk phase occupying from about 10% to about 60%, or generally about 33%, of the total beverage volume. Traditional cappuccino machines introduce high-pressure, super-heated steam into a milk-containing liquid to agitate and slightly scald the milk, producing small bubbles surrounded by a flexible, relatively stable film of partially scalded milk. The result is a delicate foam distinctive of traditional cappuccino.

But cappuccino is difficult to prepare, requiring heavy machinery to produce the pressurized, superheated steam traditionally necessary to create cappuccino foam. The required equipment, operator skill, and preparation time render cappuccino unprofitable for most of the restaurant industry.

Foams may be made more stable by adding thickeners to increase viscosity. However, highly viscous foams generally have slimy textures and are not palatable for certain uses, for example, as cappuccino foams. Where viscosities are high (i.e. above 400 cp), the formulation behaves more like a gel, and it becomes difficult to dissolve gas into the formulation, resulting in a less delicate texture.

Various foams having a suitably low viscosity and desired texture for use in hot beverages typically break down quickly in the presence of fats, oils, alcohol, or upon mechanical agitation, such as stirring. For cappuccino foams and other hot beverage foams, low fat or nonfat (skim) milk is easiest to froth, as fat can be a foam destabilizer, particularly in the presence of heat.

Whipped cream-like foams can be prepared from heavy cream or other high fat liquids, and can be relatively stable in cool environments, since, at high fat concentrations (e.g. from about 20 wt. % to about 35 wt. %), the fat forms a network when whipped which remains relatively stable at low to ambient temperatures. However, high fat foams tend to break down or liquefy quickly in the presence of heat, as the fat melts. Also, the consistency of whipped cream may not be suitable for certain applications, such as cappuccino, coffee, or other beverage foams. Furthermore, where a whipped cream consistency is desirable, the high fat content generally necessary to produce whipped cream may be of dietetic concern.

There is a need for edible foams that can be formulated to have a variety of textures, but that also demonstrate enhanced stability in warm or hot environments, despite the presence of fat and/or alcohol, and despite mechanical agitation. There is also a need for methods of preparing such foams without costly equipment, costly employee training, or lengthy preparation times.

### SUMMARY OF THE INVENTION

The invention provides new formulations for palatable foams with enhanced stability. The formulations are versatile and can be adapted to create foams of various fat content, textures, and foam stabilities. The foams can be created with simple aeration systems such as disposable, pressurized canisters, as well as high-speed, bulk dispensation systems that are currently used in high turnover restaurants and convenience stores.

In certain embodiments, cappuccino foams are prepared with the stability, desirable consistency, and/or small bubble size of traditional cappuccino, but without the need for special equipment, costly employee training, or lengthy preparation times.

Furthermore, in other embodiments, whipped-cream type foam formulations are presented that have enhanced stability, and that can be made, for example, with fat free milk, low fat milk, or soy milk, rather than heavy cream or whipping cream.

Foam formulations are presented that are tolerant of high, low, or varying fat concentration, and/or high alcohol concentration, that have enhanced stability in warm and/or hot environments, and that are tolerant of mechanical agitation, such as stirring, without significant breakdown over a period of time. For example, the foam remains substantially stable from foam preparation (e.g. upon serving or dispensing of the beverage) to consumption, during which time the consumer would most appreciate the foam. In certain embodiments, “substantially stable” means the foam maintains at least about 75% of its height after five minutes.

Formulations containing a base liquid (such as milk), a surfactant, a particular polysaccharide (as discussed herein), and a polymer capable of molecular interaction with the polysaccharide, can form foams upon aeration via standard aeration systems, such as disposable pressurized canisters, as well as high-speed, bulk dispensation systems. Foams created with such formulations are surprisingly stable, and the amounts and types of the ingredients may be adapted to create foams having a variety of textures and consistencies, including cappuccino foams that have the texture, consistency, palatability, bubble size, and stability of traditional cappuccino. Such foams are surprisingly versatile, remaining stable despite a high or low concentration of fat.

The polysaccharides that work best are high average molecular weight macromolecules (average molecular weight above about 10,000 Da), preferably with a high concentration of charge groups, for example, from about 0.25 to about 4 anionic groups per repeating monosaccharide unit, or, more preferably, from about 0.5 to about 3 anionic groups per repeating monosaccharide unit. These polysaccharides are members of a larger group of substances referred to herein as “edible carboxylic acid macromolecules” (ECM), which are edible substances containing high molecular weight molecules(average molecular weight above about 10,000 Da) that contain carboxylic acid groups (and/or alkyl esters and/or salts thereof). ECMs preferably dissolve completely in water or form hydrocolloids, hydrogels, or other structures that swell significantly in water. Examples of ECMs include, for example, pectin, alginic acid, cellulose gum, xanth gum, gellan gum, and their salts (e.g. sodium salts). In certain embodiments, ECMs with lower average molecular weight may be able to work; however, higher concentrations may be required and the resulting formulation may not be as stable.

The best performing polysaccharides were those containing galacturonic acid units, galacturonic acid alkyl ester units (i.e. methyl ester), and/or galacturonic acid salt (e.g. sodium salt). Such polysaccharides are found in pectin, and provide a foundation for versatile applications from cappuccino foams to whipped cream-type foams. In particular, especially for whipped cream-type foams, low methoxy pectin and/or amidated pectin is very calcium sensitive and is preferred. Such compounds, in combination with the other components of the foam, maintain the network required to keep the foam shape, without inordinately increasing viscosity and without degrading the desired texture and mouth feel of the foam.

The polymer(s) capable of molecular interaction with the polysaccharide is preferably an edible, water soluble polymer which may or may not be an ECM. In certain preferred embodiments, the polymer includes carboxymethylcellulose, maltodextrin, and/or protein(s), and the nature of the molecular interaction with the polysaccharide includes ionic interaction, hydrogen bonding, and/or backbone alignment. The interaction helps to strengthen the foam network created with the polysaccharide, and may help to make the foam network more resistant to break down in the presence (or absence) of fat, in the presence of heat, and/or in the event of mechanical agitation (e.g. stirring). In certain embodiments, mixtures containing both carboxymethylcellulose and pectin, particularly low methoxy and/or amidated pectin, provide exceptional stability and tolerance of fat concentration (high or low), mechanical agitation (i.e. stirring), and heat. In certain embodiments in which the polymer capable of molecular interaction with the polysaccharide is a protein, the polysaccharide interacts with the protein via ionic interaction. In certain embodiments in which carboxymethylcellulose and/or maltodextrin is/are used as polymer capable of molecular interaction with the polysaccharide, the polysaccharide interacts with the polymer via hydrogen bonding and/or backbone alignment.

In certain whipped cream-type applications, slight to moderate warming of the base liquid upon mixing may help promote dissolution of ECM into the liquid, and/or may allow enhanced dissolution and capture of the aerating gas within the foam network. In certain embodiments, maltodextrin and/or other “solids” may be added to provide a desired thicker texture, and may promote stability.

It is believed that the presence of ions, preferably polyvalent ions, such as Ca²⁺, contributes to the stability and versatility of the foam network. These ions are present naturally in the base liquid (i.e. milk), or they may optionally be added in either the formulation (which is aerated into a foam), or in the target liquid (i.e. the coffee into or onto which the foam is dispensed), in any of a variety of forms.

In preferred embodiments, the formulations presented herein are versatile enough to be dispensed in any of a variety of ways. For example, the foam may be dispensed using common pressurized canisters (i.e. whipped cream dispensers), in mechanical milk frothers, and/or in at-home cappuccino makers. In certain embodiments, foam and/or beverages containing foam may be dispensed using existing mass dispensing units, as is commonly used for soft drinks, for example, substituting nitrous oxide for carbon dioxide (although carbon dioxide or other gases may be used), and substituting the formulation for soda syrup.

As used herein, “a” when used with a compound denotes “at least one of” a given compound. For example, a mixture including a base liquid, a surfactant, a polysaccharide, and a polymer capable of molecular interaction with the polysaccharide, may contain one or more base liquids, one or more surfactants, one or more polysaccharides, and/or one or more polymers capable of interaction with one or more of the polysaccharide(s).

In one aspect, the invention relates to an edible foam including a base liquid; a surfactant; a polysaccharide having units of galacturonic acid, galacturonic acid alkyl ester, and/or galacturonic acid salt (e.g. sodium salt); and a polymer capable of molecular interaction with the polysaccharide. The source of the polysaccharide may be pectin, for example. Preferably, the pectin has a degree of esterification less than about 50 (e.g. the pectin is a “low methyl ester” or “LM” pectin with less than 50% methyl ester groups). In certain preferred embodiments, the pectin is amidated. Preferably, the pectin has an average molecular weight of at least about 50,000 Da.

In certain embodiments, the polysaccharide has an average molecular weight of at least about 15,000 Da, of at least about 20,000 Da, of at least about 25,000 Da, of at least about 30,000 Da, of at least about 35,000 Da, of at least about 40,000 Da, of at least about 45,000 Da, of at least about 50,000 Da, of at least about 60,000 Da, of at least about 70,000 Da, of at least about 80,000 Da, of at least about 90,000 Da, or of at least about 100,000 Da.

In certain embodiments, the polysaccharide has from about 0.25 to about 4 anionic groups per repeating monosaccharide unit. In certain embodiments, the polysaccharide has from about 0.5 to about 3 anionic groups per repeating monosaccharide unit. In certain embodiments, the polysaccharide has from about 1 to about 2 anionic groups per repeating monosaccharide unit.

In certain embodiments, the polymer capable of molecular interaction with the polysaccharide includes carboxymethylcellulose. Preferably, the polymer is edible and water soluble.

In certain embodiments, the polymer capable of molecular interaction with the polysaccharide includes a protein. The protein may include, for example, one or more of the following: dairy protein, dairy whey, whey protein whey protein concentrate, whey protein isolate, casein, egg protein, dried egg, egg white, dried egg white, egg albumin, egg albumen, ovalbumin, lactalbumin, lysozyme, soy protein, rice protein, pea protein, wheat protein, corn protein, vegetable protein, wheat gluten, gelatin, and serum albumin.

In certain embodiments, the polymer capable of molecular interaction with the polysaccharide includes one or more of the following: xanth gum, alginic acid, alignate, gum Arabic, acacia gum, gum tragacanth, chitin, beta-glucan, glycosaminoglycan, agar, carrageenan, guar gum, glucomannan, and any salt thereof.

In certain embodiments, the base liquid includes one or more of the following: milk, nonfat milk, whole milk, partially reduced fat milk, low fat milk, skim milk, cream, heavy cream, bakers cream, half and half, goat milk, soy milk, rice milk, lactose free milk, nondairy creamer, yogurt, reconstituted dry milk, melted ice cream, ghee, and melted butter. In certain embodiments, the base liquid is water.

In certain embodiments, the foam is aerated with one or more of the following: air, nitrogen, oxygen, carbon dioxide, helium, nitrous oxide, hydrogen, and dimethyl ether.

In certain embodiments, the surfactant includes one or more of the following: an alkyl sulfonate, an alkyl lactylate, an alkyl acyl lactylate, a quaternary alkyl surfactant, a benzalkonium, a sorbitan ester, and any salt thereof. For example, the surfactant may include sodium stearoyl lactylate.

In certain embodiments, the foam includes one or more polyvalent cations. The one or more polyvalent cations may include, for example, Ca²⁺, Mg²⁺, Fe²⁺, Fe³⁺, and/or Al³⁺. In certain embodiments, the foam includes Ca²⁺.

In preferred embodiments, the foam contains from about 0.16 wt. % to about 0.33 wt. % surfactant, from about 0.33 wt. % to about 2.0 wt. % polysaccharide, and from about 0.33 wt. % to about 10.0 wt. % polymer (the polymer capable of interaction with the polysaccharide), although useful compositions outside these ranges are possible. In certain embodiments the foam contains from about 0.16 wt. % to about 0.33 wt. % surfactant, from about 0.33 wt. % to about 10.0 wt. % polysaccharide, and from about 0.33 wt. % to about 10.0 wt. % polymer. In certain embodiments, the foam contains from about 0.16 wt. % to about 0.33 wt. % surfactant, from about 0.33 wt. % to about 2.0 wt. % polysaccharide, and from about 0.33 wt. % to about 2.0 wt. % polymer. In certain embodiments, the total amount of surfactant is less than about 0.33 wt. %, less than about 0.25 wt. %, less than about 0.15 wt. %, or less than about 0.10 wt. %. In certain embodiments, the total amount of polysaccharide is less than about 10.0 wt. %, less than about 7.5 wt. %, less than about 5.0 wt. %, less than about 3.0 wt. %, less than about 2.0 wt. %, less than about 1.0 wt. %, or less than about 0.5 wt. %. In certain embodiments, the total amount of polymer is less than about 10.0 wt. %, less than about 7.5 wt. %, less than about 5.0 wt. %, less than about 3.0 wt. %, less than about 2.0 wt. %, less than about 1.0 wt. %, or less than about 0.5 wt. %. In certain embodiments, the total combined amount of polysaccharide and polymer capable of molecular interaction with the polysaccharide, in the foam, is less than about 20.0 wt. %, less than about 15 wt. %, less than about 10 wt. %, less than about 6.0 wt. %, less than about 4.0 wt. %, less than about 2.0 wt. %, or less than about 1.0 wt. %. In certain embodiments, the total amount of surfactant, polysaccharide, and polymer capable of molecular interaction with the polysaccharide, in the foam, is less than about 20.0 wt. %, less than about 15 wt. %, less than about 10 wt. %, less than about 6.0 wt. %, less than about 4.0 wt. %, less than about 2.0 wt. %, or less than about 1.0 wt. %.

In certain embodiments, the formulation comprises one or more of the following: sweetener(s), natural and/or artificial flavor(s), preservative(s), chocolate, alcohol, and natural and/or artificial color(s). In certain embodiments, the formulation comprises at least about 0.5 wt. % alcohol, at least about 1.0 wt. % alcohol, at least about 2.5 wt. % alcohol, at least about 3.5 wt. % alcohol, at least about 5.0 wt. % alcohol, at least about 7.5 wt. % alcohol, at least about 10 wt. % alcohol, at least about 25 wt. % alcohol, at least about 35 wt. % alcohol, or at least about 50 wt. % alcohol.

In certain embodiments, the foam maintains at least about 65% of its height after five minutes. In certain embodiments, the foam maintains at least about 75% of its height after five minutes. In certain embodiments, the foam maintains at least about 80% of its height after five minutes. In certain embodiments, the foam maintains at least about 90% of its height after five minutes. In certain embodiments, the foam maintains at least about 65% of its height after five minutes on a target liquid, for example, on coffee, espresso, cider, beer, alcohol, and/or carbonated water; in certain embodiments, the target liquid is at least about 60° C., at least about 70° C., or at least about 80° C. In certain embodiments, the foam maintains at least about 75% of its height after five minutes on a target liquid, for example, on coffee, espresso, cider, beer, alcohol, and/or carbonated water; in certain embodiments, the target liquid is at least about 60° C., at least about 70° C., or at least about 80° C. In certain embodiments, the foam maintains at least about 80% of its height after five minutes on a target liquid, for example, on coffee, espresso, cider, beer, alcohol, and/or carbonated water; in certain embodiments, the target liquid is at least about 60° C., at least about 70° C., or at least about 80° C. In certain embodiments, the foam maintains at least about 90% of its height after five minutes on a target liquid, for example, on coffee, espresso, cider, beer, alcohol, and/or carbonated water; in certain embodiments, the target liquid is at least about 60° C., at least about 70° C., or at least about 80° C.

In certain embodiments, the foam has a viscosity from about 1 cp to about 400 cp; from about 10 cp to about 300 cp, from about 20 cp to about 200 cp, or from about 30 to about 150 cp. In certain embodiments, the foam has a viscosity below about 250 cp, below about 200 cp, below about 150 cp, or below about 100 cp, yet maintains at least about 65%, at least about 75%, at least about 80%, or at least about 90% of its height after five minutes on a target liquid, for example, on coffee, espresso, cider, beer, alcohol, and/or carbonated water; where, optionally, the target liquid is at least about 60° C., at least about 70° C., or at least about 80° C.

In certain embodiments, the foam has a whipped cream consistency. In certain embodiments, the foam has a whipped cream consistency without substantially liquefying for at least about 30 seconds, at least about 60 seconds, at least about 90 seconds, or at least about 120 seconds under ambient conditions, under conditions of about 30° C. or higher, under conditions of about 35° C. or higher, under conditions of about 45° C. or higher, under conditions of about 60° C. or higher, under conditions of about 70° C. or higher, or under conditions of about 80° C. or higher. In certain embodiments, “without substantially liquefying” means having a volume loss of about 10% or less. In certain embodiments where the foam has a whipped cream consistency, its viscosity is from about 100 cp to about 400 cp, or from about 150 cp to about 250 cp.

In certain embodiments, the foam is dispensed from a pressurized container. In certain embodiments, the foam is dispensed from a restaurant beverage dispensation system. In certain embodiments, the foam is dispensed from a high-volume beverage dispensation system through a push-activated nozzle. In certain embodiments, the beverage dispensation system comprises a compressed gas cylinder, a liquid reservoir, a mixing chamber, a dispensing nozzle, and, optionally, a heating element.

In another aspect, the invention relates to an edible foam comprising a base liquid; a surfactant; a polysaccharide having an average molecular weight of at least about 10,000 Da and having from about 0.25 to about 4 anionic groups per repeating monosaccharide unit; and a polymer capable of molecular interaction with the polysaccharide. In certain embodiments, the polysaccharide includes at least one of the following monosaccharide units: tetrose, pentose, hexose, and heptose. In certain embodiments, the polysaccharide includes pentose and/or hexose. In preferred embodiments, the polysaccharide has from about 0.5 to about 3 anionic groups per repeating monosaccharide unit. In certain embodiments, the polysaccharide has from about 1 to about 2 anionic groups per repeating monosaccharide unit.

In certain embodiments, the foam includes at least one of the following: pectin having a degree of esterification less than about 50, amidated pectin, carboxymethylcellulose, xanth gum, alginic acid, alginate, gum Arabic, acacia gum, gum tragacanth, chitin, beta-glucan, glycosaminoglycan, agar, carrageenan, guar gum, glucomannan, and any salt thereof.

In preferred embodiments, the polymer capable of molecular interaction with the polysaccharide is edible and/or water soluble. In certain embodiments, the polymer includes maltodextrin. In certain embodiments, the polymer includes protein. The protein may include, for example, one or more of the following: dairy protein, dairy whey, whey protein whey protein concentrate, whey protein isolate, casein, egg protein, dried egg, egg white, dried egg white, egg albumin, egg albumen, ovalbumin, lactalbumin, lysozyme, soy protein, rice protein, pea protein, wheat protein, corn protein, vegetable protein, wheat gluten, gelatin, and serum albumin.

In certain embodiments, the surfactant includes one or more of the following: an alkyl sulfonate, an alkyl lactylate, an alkyl acyl lactylate, a quaternary alkyl surfactant, a benzalkonium, a sorbitan ester, and any salt thereof. For example, the surfactant may include sodium stearoyl lactylate.

In certain embodiments, the base liquid includes one or more of the following: milk, nonfat milk, whole milk, partially reduced fat milk, low fat milk, skim milk, cream, heavy cream, bakers cream, half and half, goat milk, soy milk, rice milk, lactose free milk, nondairy creamer, yogurt, reconstituted dry milk, melted ice cream, ghee, and melted butter. In certain embodiments, the base liquid is water.

In certain embodiments, the foam includes one or more polyvalent cations. The one or more polyvalent cations may include, for example, Ca²⁺, Mg²⁺, Fe²⁺, Fe³⁺, and/or Al³⁺. In certain embodiments, the foam includes Ca²⁺.

In certain embodiments, the polysaccharide has an average molecular weight of at least about 15,000 Da, of at least about 20,000 Da, of at least about 25,000 Da, of at least about 30,000 Da, of at least about 35,000 Da, of at least about 40,000 Da, of at least about 45,000 Da, of at least about 50,000 Da, of at least about 60,000 Da, of at least about 70,000 Da, of at least about 80,000 Da, of at least about 90,000 Da, or of at least about 100,000 Da.

In certain embodiments, the foam maintains at least about 65% of its height after five minutes. In certain embodiments, the foam maintains at least about 75% of its height after five minutes. In certain embodiments, the foam maintains at least about 80% of its height after five minutes. In certain embodiments, the foam maintains at least about 90% of its height after five minutes. In certain embodiments, the foam maintains at least about 65% of its height after five minutes on a target liquid, for example, on coffee, espresso, cider, beer, alcohol, and/or carbonated water; in certain embodiments, the target liquid is at least about 60° C., at least about 70° C., or at least about 80° C. In certain embodiments, the foam maintains at least about 75% of its height after five minutes on a target liquid, for example, on coffee, espresso, cider, beer, alcohol, and/or carbonated water; in certain embodiments, the target liquid is at least about 60° C., at least about 70° C., or at least about 80° C. In certain embodiments, the foam maintains at least about 80% of its height after five minutes on a target liquid, for example, on coffee, espresso, cider, beer, alcohol, and/or carbonated water; in certain embodiments, the target liquid is at least about 60° C., at least about 70° C., or at least about 80° C. In certain embodiments, the foam maintains at least about 90% of its height after five minutes on a target liquid, for example, on coffee, espresso, cider, beer, alcohol, and/or carbonated water; in certain embodiments, the target liquid is at least about 60° C., at least about 70° C., or at least about 80° C.

In certain embodiments, the foam has a viscosity from about 1 cp to about 400 cp; from about 10 cp to about 300 cp, from about 20 cp to about 200 cp, or from about 30 cp to about 150 cp. In certain embodiments, the foam has a viscosity below about 250 cp, below about 200 cp, below about 150 cp, or below about 100 cp, yet maintains at least about 65%, at least about 75%, at least about 80%, or at least about 90% of its height after five minutes on a target liquid, for example, on coffee, espresso, cider, beer, alcohol, and/or carbonated water; where, optionally, the target liquid is at least about 60° C., at least about 70° C., or at least about 80° C.

In certain embodiments, the foam has a whipped cream consistency. In certain embodiments, the foam has a whipped cream consistency without substantially liquefying for at least about 30 seconds, at least about 60 seconds, at least about 90 seconds, or at least about 120 seconds under ambient conditions, under conditions of about 30° C. or higher, under conditions of about 35° C. or higher, under conditions of about 45° C. or higher, under conditions of about 60° C. or higher, under conditions of about 70° C. or higher, or under conditions of about 80° C. or higher. In certain embodiments, “without substantially liquefying” means having a volume loss of about 10% or less. In certain embodiments where the foam has a whipped cream consistency, its viscosity is from about 100 cp to about 400 cp, or from about 150 cp to about 250 cp.

In preferred embodiments, the foam contains from about 0.16 wt. % to about 0.33 wt. % surfactant, from about 0.33 wt. % to about 2.0 wt. % polysaccharide, and from about 0.33 wt. % to about 10.0 wt. % polymer (the polymer capable of interaction with the polysaccharide), although useful compositions outside these ranges are possible. In certain embodiments the foam contains from about 0.16 wt. % to about 0.33 wt. % surfactant, from about 0.33 wt. % to about 10.0 wt. % polysaccharide, and from about 0.33 wt. % to about 10.0 wt. % polymer. In certain embodiments, the foam contains from about 0.16 wt. % to about 0.33 wt. % surfactant, from about 0.33 wt. % to about 2.0 wt. % polysaccharide, and from about 0.33 wt. % to about 2.0 wt. % polymer. In certain embodiments, the total amount of surfactant is less than about 0.33 wt. %, less than about 0.25 wt. %, less than about 0.15 wt. %, or less than about 0.10 wt. %. In certain embodiments, the total amount of polysaccharide is less than about 10.0 wt. %, less than about 7.5 wt. %, less than about 5.0 wt. %, less than about 3.0 wt. %, less than about 2.0 wt. %, less than about 1.0 wt. %, or less than about 0.5 wt. %. In certain embodiments, the total amount of polymer is less than about 10.0 wt. %, less than about 7.5 wt. %, less than about 5.0 wt. %, less than about 3.0 wt. %, less than about 2.0 wt. %, less than about 1.0 wt. %, or less than about 0.5 wt. %. In certain embodiments, the total combined amount of polysaccharide and polymer capable of molecular interaction with the polysaccharide, in the foam, is less than about 20.0 wt. %, less than about 15 wt. %, less than about 10 wt. %, less than about 6.0 wt. %, less than about 4.0 wt. %, less than about 2.0 wt. %, or less than about 1.0 wt. %. In certain embodiments, the total amount of surfactant, polysaccharide, and polymer capable of molecular interaction with the polysaccharide, in the foam, is less than about 20.0 wt. %, less than about 15 wt. %, less than about 10 wt. %, less than about 6.0 wt. %, less than about 4.0 wt. %, less than about 2.0 wt. %, or less than about 1.0 wt. %.

In certain embodiments, the foam is dispensed from a pressurized container. In certain embodiments, the foam is dispensed from a restaurant beverage dispensation system. In certain embodiments, the foam is dispensed from a high-volume beverage dispensation system through a push-activated nozzle. In certain embodiments, the beverage dispensation system comprises a compressed gas cylinder, a liquid reservoir, a mixing chamber, a dispensing nozzle, and, optionally, a heating element.

In yet another aspect, the invention relates to a liquid that is capable of forming an edible foam upon aeration, the liquid including: (a) at least one of the following: milk, nonfat milk, whole milk, partially reduced fat milk, low fat milk, cream, heavy cream, bakers cream, half and half, goat milk, soy milk, rice milk, lactose free milk, nondairy creamer, yogurt, reconstituted dry milk, melted ice cream, ghee, and melted butter; (b) a surfactant; (c) polysaccharide having units of galacturonic acid, galacturonic acid alkyl ester, and/or galacturonic acid salt; and (d) carboxymethylcellulose. The source of the polysaccharide may be pectin, for example. Preferably, the pectin has a degree of esterification less than about 50 (e.g. the pectin is a “low methyl ester” or “LM” pectin with less than 50% methyl ester groups). In certain preferred embodiments, the pectin is amidated. Preferably, the pectin has an average molecular weight of at least about 50,000 Da.

In certain embodiments, the liquid includes at least one of the following: pectin having a degree of esterification less than about 50, amidated pectin, carboxymethylcellulose, maltodextrin, xanth gum, alginic acid, alginate, gum Arabic, acacia gum, gum tragacanth, chitin, beta-glucan, glycosaminoglycan, agar, carrageenan, guar gum, glucomannan, and any salt thereof.

In certain embodiments, the liquid further includes protein. The protein may include, for example, one or more of the following: dairy protein, dairy whey, whey protein whey protein concentrate, whey protein isolate, casein, egg protein, dried egg, egg white, dried egg white, egg albumin, egg albumen, ovalbumin, lactalbumin, lysozyme, soy protein, rice protein, pea protein, wheat protein, corn protein, vegetable protein, wheat gluten, gelatin, and serum albumin.

In certain embodiments, the surfactant includes one or more of the following: an alkyl sulfonate, an alkyl lactylate, an alkyl acyl lactylate, a quaternary alkyl surfactant, a benzalkonium, a sorbitan ester, and any salt thereof. For example, the surfactant may include sodium stearoyl lactylate.

In certain embodiments, the liquid includes one or more polyvalent cations. The one or more polyvalent cations may include, for example, Ca²⁺, Mg²⁺, Fe²⁺, Fe³⁺, and/or Al³⁺. In certain embodiments, the liquid includes Ca²⁺.

In certain embodiments, the polysaccharide has an average molecular weight of at least about 15,000 Da, of at least about 20,000 Da, of at least about 25,000 Da, of at least about 30,000 Da, of at least about 35,000 Da, of at least about 40,000 Da, of at least about 45,000 Da, of at least about 50,000 Da, of at least about 60,000 Da, of at least about 70,000 Da, of at least about 80,000 Da, of at least about 90,000 Da, or of at least about 100,000 Da.

In certain embodiments, the liquid is capable of forming an edible foam upon aeration, where the foam maintains at least about 65% of its height after five minutes. In certain embodiments, the foam maintains at least about 75% of its height after five minutes. In certain embodiments, the foam maintains at least about 80% of its height after five minutes. In certain embodiments, the foam maintains at least about 90% of its height after five minutes. In certain embodiments, the foam maintains at least about 65% of its height after five minutes on a target liquid, for example, on coffee, espresso, cider, beer, alcohol, and/or carbonated water; in certain embodiments, the target liquid is at least about 60° C., at least about 70° C., or at least about 80° C. In certain embodiments, the foam maintains at least about 75% of its height after five minutes on a target liquid, for example, on coffee, espresso, cider, beer, alcohol, and/or carbonated water; in certain embodiments, the target liquid is at least about 60° C., at least about 70° C., or at least about 80° C. In certain embodiments, the foam maintains at least about 80% of its height after five minutes on a target liquid, for example, on coffee, espresso, cider, beer, alcohol, and/or carbonated water; in certain embodiments, the target liquid is at least about 60° C., at least about 70° C., or at least about 80° C. In certain embodiments, the foam maintains at least about 90% of its height after five minutes on a target liquid, for example, on coffee, espresso, cider, beer, alcohol, and/or carbonated water; in certain embodiments, the target liquid is at least about 60° C., at least about 70° C., or at least about 80° C.

In certain embodiments, the liquid is capable of forming an edible foam upon aeration, where the foam has a viscosity from about 1 cp to about 400 cp; from about 10 cp to about 300 cp, from about 20 cp to about 200 cp, or from about 30 to about 150 cp. In certain embodiments, the foam has a viscosity below about 250 cp, below about 200 cp, below about 150 cp, or below about 100 cp, yet maintains at least about 65%, at least about 75%, at least about 80%, or at least about 90% of its height after five minutes on a target liquid, for example, on coffee, espresso, cider, beer, alcohol, and/or carbonated water; where, optionally, the target liquid is at least about 60° C., at least about 70° C., or at least about 80° C.

In certain embodiments, the liquid is capable of forming an edible foam upon aeration, where the foam has a whipped cream consistency. In certain embodiments, the foam has a whipped cream consistency without substantially liquefying for at least about 30 seconds, at least about 60 seconds, at least about 90 seconds, or at least about 120 seconds under ambient conditions, under conditions of about 30° C. or higher, under conditions of about 35° C. or higher, under conditions of about 45° C. or higher, under conditions of about 60° C. or higher, under conditions of about 70° C. or higher, or under conditions of about 80° C. or higher. In certain embodiments, “without substantially liquefying” means having a volume loss of about 10% or less. In certain embodiments where the foam has a whipped cream consistency, its viscosity is from about 100 cp to about 400 cp, or from about 150 cp to about 250 cp.

In preferred embodiments, the liquid contains from about 0.16 wt. % to about 0.33 wt. % surfactant, from about 0.33 wt. % to about 2.0 wt. % polysaccharide, and from about 0.33 wt. % to about 10.0 wt. % carboxymethylcellulose, although useful compositions outside these ranges are possible. In certain embodiments the foam contains from about 0.16 wt. % to about 0.33 wt. % surfactant, from about 0.33 wt. % to about 10.0 wt. % polysaccharide, and from about 0.33 wt. % to about 10.0 wt. % carboxymethylcellulose. In certain embodiments, the foam contains from about 0.16 wt. % to about 0.33 wt. % surfactant, from about 0.33 wt. % to about 2.0 wt. % polysaccharide, and from about 0.33 wt. % to about 2.0 wt. % carboxymethylcellulose. In certain embodiments, the total amount of surfactant is less than about 0.33 wt. %, less than about 0.25 wt. %, less than about 0.15 wt. %, or less than about 0.10 wt. %. In certain embodiments, the total amount of polysaccharide is less than about 10.0 wt. %, less than about 7.5 wt. %, less than about 5.0 wt. %, less than about 3.0 wt. %, less than about 2.0 wt. %, less than about 1.0 wt. %, or less than about 0.5 wt. %. In certain embodiments, the total amount of carboxymethylcellulose is less than about 10.0 wt. %, less than about 7.5 wt. %, less than about 5.0 wt. %, less than about 3.0 wt. %, less than about 2.0 wt. %, less than about 1.0 wt. %, or less than about 0.5 wt. %. In certain embodiments, the total combined amount of polysaccharide and carboxymethylcellulose in the liquid, is less than about 20.0 wt. %, less than about 15 wt. %, less than about 10 wt. %, less than about 6.0 wt. %, less than about 4.0 wt. %, less than about 2.0 wt. %, or less than about 1.0 wt. %. In certain embodiments, the total amount of surfactant, polysaccharide, and carboxymethylcellulose in the liquid is less than about 20.0 wt. %, less than about 15 wt. %, less than about 10 wt. %, less than about 6.0 wt. %, less than about 4.0 wt. %, less than about 2.0 wt. %, or less than about 1.0 wt. %.

In certain embodiments, the liquid is capable of forming an edible foam upon aeration, where the foam is dispensed from a pressurized container. In certain embodiments, the foam is dispensed from a restaurant beverage dispensation system. In certain embodiments, the foam is dispensed from a high-volume beverage dispensation system through a push-activated nozzle. In certain embodiments, the beverage dispensation system comprises a compressed gas cylinder, a liquid reservoir, a mixing chamber, a dispensing nozzle, and, optionally, a heating element.

### BRIEF DESCRIPTION OF DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a schematic drawing illustrating the interaction of an ECM with protein films formed around air or other gas bubbles in a foam, according to an illustrative embodiment of the invention.

FIG. 2 is a schematic drawing illustrating the interaction of calcium with hydrated solutions or suspensions of ECM(s), according to an illustrative embodiment of the invention.

FIG. 3 is a schematic drawing illustrating a mechanism for the binding of ECM to calcium, enhancing foam stability without undesired viscosity increase, according to an illustrative embodiment of the invention.

FIG. 4 is a schematic drawings illustrating the interaction of surfactant(s) with oil or fat micelles (present in milk and other creamy liquids), and the interaction of surfactant(s) with the macromolecular network of foam via cation bridges, thereby enhancing foam stability in the presence of fat and/or oil, according to an illustrative embodiment of the invention.

FIG. 5 is a drawing of a pressurized, disposable can for dispensation of foam, according to an illustrative embodiment of the invention.

FIG. 6 is a schematic drawing of a high volume dispensation system for foams and/or foamed beverages, according to an illustrative embodiment of the invention.

### DETAILED DESCRIPTION

In certain embodiments, the invention provides foam formulations and methods of rapidly dispensing foams with satisfactory bubble size, texture, viscosity, consistency, and/or mouth feel for a variety of applications. For example, in certain embodiments, such foam is similar to the foam found atop traditionally-prepared cappuccinos, having similarly small bubble size, low viscosity, and delicate texture.

In certain embodiments, the invention includes a base liquid, one or more ECMs, one or more proteins and/or water soluble polymers such as carboxymethylcellulose and/or maltodextrin, and one or more emulsifiers such as sodium stearoyl lactylate. The ECM is preferably of high molecular weight and swells and/or completely dissolves in an aqueous solution or suspension (e.g. milk and/or other base liquids). The ECM preferably contains a high degree of anionic substitution as well, preferably in the range of 0.25 to 4 anionic groups per repeating unit. The protein or water soluble polymer interacts with the functional groups of the ECM dissolved in a liquid such as milk or water. The surfactant or emulsifier acts to further stabilize the bubbles in the foam. The mixture is aerated with a pressurized gas and dispensed through a nozzle into or on top of a target liquid such as coffee, espresso or tea. Alternatively, the foam may be dispensed and used as a topping or ingredient for pastry or any other food or beverage where foam is desirable.

It is contemplated that methods, systems, and processes described herein encompass variations and adaptations developed using information from the embodiments described herein.

Throughout the description, where products, systems, formulations, compositions, mixtures, and blends are described as having, including, or comprising specific components, or where processes and methods are described as having, including, or comprising specific steps, it is contemplated that, additionally, there are products, systems, formulations, compositions, mixtures, and blends of the present invention that consist essentially of, or consist of, the recited components, and that there are processes and methods of the present invention that consist essentially of, or consist of, the recited processing steps.

The mention herein of any publication, for example, in the Background section, is not an admission that the publication serves as prior art with respect to any of the claims presented herein. The Background section is presented for purposes of clarity and is not meant as a description of prior art with respect to any claim.

As used herein, “polysaccharide” is understood to mean a biological polymer having sugar subunits, for example, a starch or a cellulose, or a derivative of such a biological polymer, for example, pectin, carboxymethyl cellulose, or chitosan.

Foam prepared according to one of the preferred embodiments is remarkably stable, versatile, and tolerates heat, high fat concentrations, and high alcohol concentrations. Depending on the application and consumer's preference, the foam can be made to closely resemble traditional cappuccino foam, or, alternatively, can be made much richer and creamier. The preferred embodiments produce foam that is both natural looking and appealing.

Additionally, the liquid can be prepared with sweeteners, chocolate, and/or other flavors and condiments to achieve other related specialty beverages familiar to those experienced in the beverage industry. The invention can be used with alternative milky liquids which are traditionally more difficult to froth such as low fat, skim milk, and soy milk. Similarly, alcoholic liquids may also be added to generate novel, new, strongly-alcoholic, foamed beverages.

The methods taught herein allow for the selection of a wide range of foam properties which may be selected to cater to the preferences of a wide range of consumers. The methods presented herein for producing cappuccino foam provides a number of advantages over previous methods.

Dissolved or hydrated ECMs act synergistically with proteins to stabilize foam. Without wishing to limit the scope of the invention, it is believed that the macromolecule interacts with protein films formed around air or gas bubbles to retain and stabilize the liquid between the bubbles of the foam.

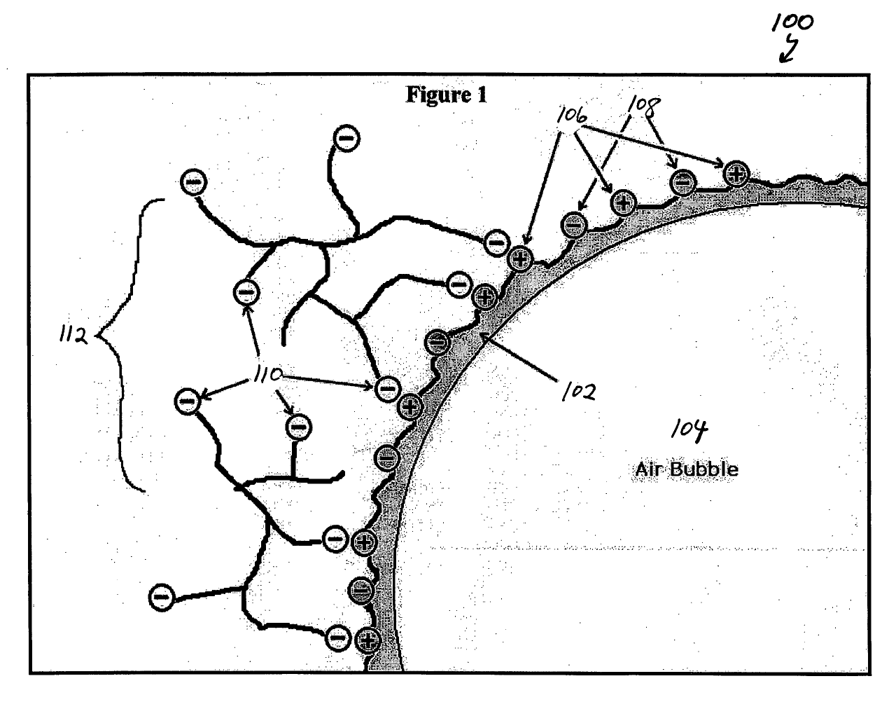

FIG. 1 is a schematic diagram 100 illustrating the interaction of an ECM with protein films formed around air or other gas bubbles in a foam. Proteins, for example proteins that are naturally present in milk, form films 102 around air bubbles 104, with hydrophobic protein functionalities at the air-liquid interface and ionic functionalities (cationic 106 and anionic 108) exposed in the liquid phase. The carboxylic acid functionalities 110 of the macromolecular network 112 are able to interact with the exposed cationic sites 106 of the protein. The water swellable or soluble macromolecules 112 form an ionically bound layer surrounding the air bubbles 104, thickening the liquid layer around each bubble and retarding the drainage of liquid from the body of foam. It is found in preferred embodiments that the most effective types of ECMs contain high degrees of anionic substitution and relatively high molecular weights. The most preferable molecular weight distributions are those which allow a portion of the material to dissolve in the base liquid and a portion to swell and form gel particles.

Though more expensive, cationic or basic-functionalized polymers or macromolecules, such as chitosan, are able to interact with protein films in an analogous manner. Due to the cost and less savory flavor, cationic macromolecules are less preferable for most beverages, but may also be used in the same spirit of the invention.

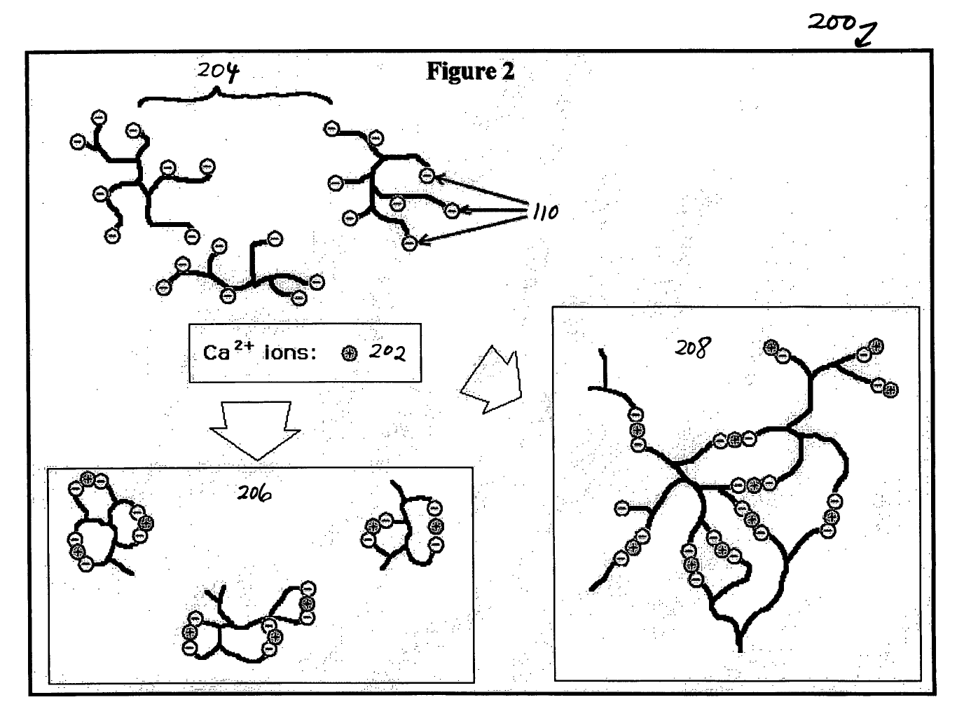

Calcium interacts with various hydrated solutions or suspensions of ECMs to produce different effects, such as viscosity increase, viscosity decrease, and gel formation. FIG. 2 is a schematic 200 illustrating how these effects arise from the formation of ionic bridges between the anionic functional groups 110. The addition of calcium ions 202 to hydrated ECMs 204 can lead to intramolecular bridging or “balling up” of macromolecules 206 which causes a subsequent decrease in viscosity. Also depicted in FIG. 2 is the intermolecular bridging of functionalities and extended network formation 208 which can lead to an increase in the viscosity of the solution, or gel formation.

The bond strength of the ionic bridge is significantly less than the strength of the sigma bonds which compose the polymer chains and macromolecules. The ionic calcium bridges between hydrated macromolecules are more easily broken and reformed, allowing the network to be physically or mechanically agitated and yet instantly reform and retain network stability. This special type of network allows for the formation of foam which is stable to being stirred, spooned, mixed or prodded with pastries and otherwise agitated by the beverage (e.g. cappuccino) drinker without being unappetizingly firm and without collapsing.

These effects can be manipulated in various ways to produce stable cappuccino foams, and other edible foams, which may be dispensed in a variety of ways. The dispensation technique for a given application may be selected to achieve an increase in viscosity upon being dispensed, heated or both. In one embodiment, the ECM is selected to be one which gels in the presence of calcium, such as low methoxy pectin or soluble alginate salts. A stream containing dissolved calcium can be injected into the foam as it is dispensed, or may be present in the coffee into which the foam is being dispensed. In certain embodiments, the dissolved calcium naturally occurring in the base liquid may well be sufficient in concentration without requiring the addition of calcium.

The result is that the foam rapidly becomes more firm as it is dispensed and is very stable. The amount of calcium added can be varied to achieve a continuous range of foam thicknesses and may be selected to yield a consistency like that of a traditionally prepared cappuccino or any consistency that the consumer may prefer.

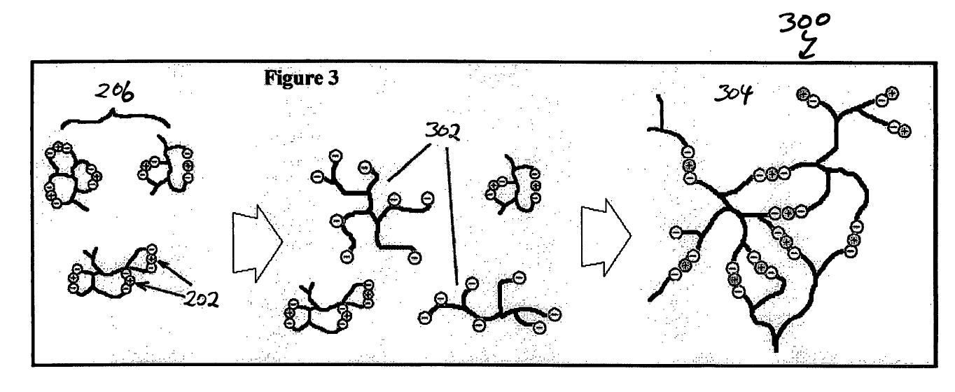

In one embodiment, ECMs are selected to form thermosetting foam which becomes firm once mixed with coffee and heated. FIG. 3 is a schematic drawing 300 illustrating a proposed mechanism by which this may occur. ECM is selected which thermoreversibly binds to calcium (see reference 206) without increasing viscosity and is added to milk or some other liquid containing calcium ions 202. After the calcium has been bound, another ECM 302 is added which is able to form extended networks in the presence of calcium. Upon dispensation and heating, the calcium is released from the first type of ECM 206 and forms an extended, crosslinked network 304 with the second ECM 302, allowing the foam to stabilize upon dispensation.

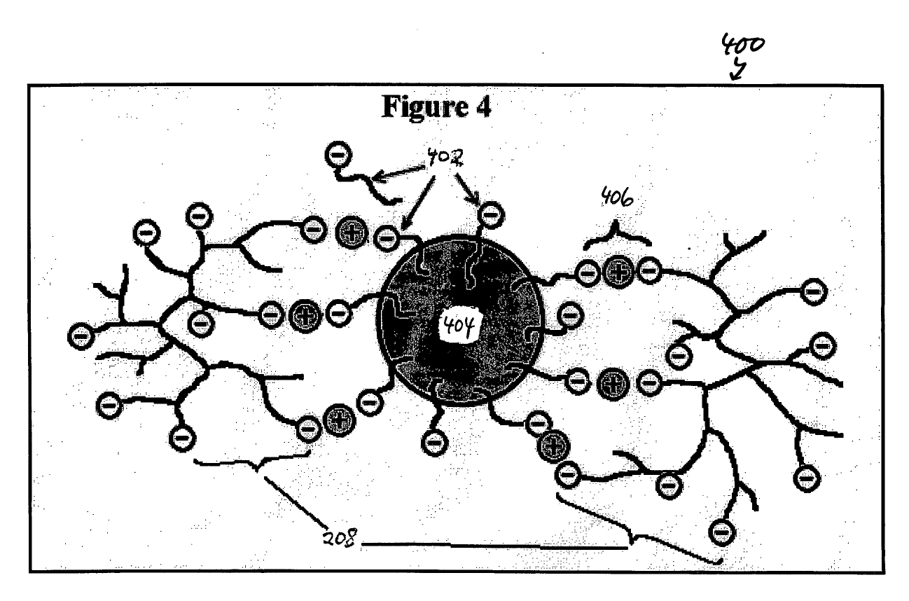

As with air and other aerating gases, proteins will form films around fat and oil micelles present in milk and other creamy liquids. An anionic surfactant can be added to the liquid to give the micelles a plurality of negative charges. FIG. 4 is a schematic drawing 400 illustrating the interaction of surfactant(s) with oil or fat micelles (present in milk and other creamy liquids), and the interaction of surfactant(s) with the macromolecular network of foam via cation bridges, thereby enhancing foam stability in the presence of fat and/or oil. Surfactant molecules 402 migrate to the surfaces of oil micelles 404, which may behave like polyanions in some regards. It is believed that surfactants 402 are able to interact with the macromolecular network 208 via ionic (cation) bridges 406 and contribute to the stability of the macromolecular network, having a diminished negative impact on the foam. Similarly, cationic surfactants may be used in an analogous manner with polyanions mediating the ionic bridging.

Through these and/or possibly other unknown mechanisms, the aforementioned combinations of ingredients are found to produce foams that are stable despite the presence of fats and oils which would otherwise be detrimental to foam stability. These formulations allow the use of a wide range of base liquids including, for example, nonfat (skim) milk, whole milk, half and half, heavy cream, melted ice cream, yogurt, and any combination thereof.

Ingredients may be added to formulations to produce high viscosity foams that are relatively stable. For example, liquids with viscosities greater than about 400 centipoise generally form stable foams without the need for complicated stabilization schemes. However, foams having excessively high viscosities tend to have slimy textures and are not palatable. When viscosities are extremely high, the formulation acts more like a gel, and it becomes difficult to properly dissolve gas into the formulation. The result is a poorly textured, poor quality foam. For example, such foams do not adequately replace cappuccino foam.

Without limiting the scope of this invention, stable foam may be defined as having stability similar to traditional cappuccino foam. Traditional cappuccino foam maintains approximately 75% of its height after 5 minutes and is stable despite mechanical agitation (e.g. stirring). This standard was used in comparing the stability of the foams in the Experimental Examples.

Established methods of containing, dispensing, and marketing pressurized dairy products, such as whipped cream and dispensed cheese (or cheese-flavored) products, may be used in conjunction with the foams presented herein. Preferred foam formulations presented herein are very versatile and may work easily with these pre-established systems and may be marketed and dispensed in a number of ways.

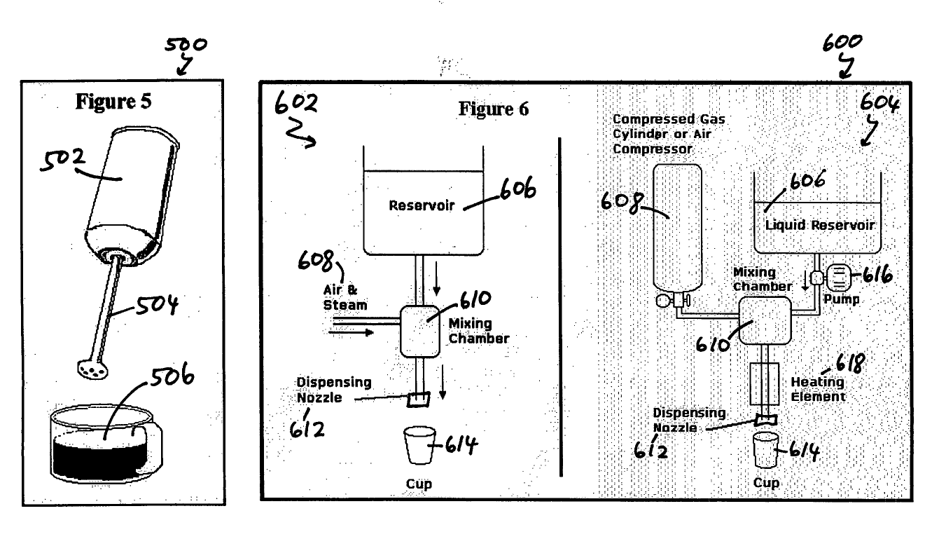

For example, in one embodiment, foam-producing formulations of certain embodiments are packaged and marketed in a manner similar to whipped cream. The foam may be dispensed through a special nozzle which may be immersed in the coffee or other target liquid during dispensation to facilitate the creaming of coffee. This also may facilitate heating of the foam, which may contribute to foam stability in certain embodiments. FIG. 5 is a drawing 500 of a pressurized, disposable can 502 for dispensation of foam through a nozzle 504 into or onto a target liquid 506, according to an illustrative embodiment of the invention.

FIG. 6 is a schematic drawing 600 of illustrative high volume dispensation systems 602, 604 for foams and/or foamed beverages. The liquid formulation is kept in a reservoir 606 and is mixed with air and/or steam 608 in a chamber or channel 610 and dispensed in large volumes through a dispensing nozzle 612, such as a push-activated nozzle, a faucet (such as a beer faucet or creamer faucet), a slow-pour nozzle, a stout faucet, or other known dispensing nozzle, into a cup 614 or other container. The system at reference 604 in FIG. 6 additionally shows a pump 616 and a heating element 618. Alternatively, the foam may be generated by introducing any edible gas into the liquid and chopping the big bubbles into smaller ones. The dispensing systems 602, 604 shown in FIG. 6 find use, for example, in fast-food restaurants, bars, convenience stores, and other establishments. Existing high-volume beverage dispensation infrastructure may be used to create various foams described herein, without the need for retrofitting.

In the Experimental Examples, surprising results were obtained using a polysaccharide containing galacturonic acid units, galacturonic acid alkyl ester units (i.e. methyl ester), and/or galacturonic acid salt, such as pectin, in combination with a base liquid (such as milk), a surfactant, and a polymer capable of molecular interaction with the polysaccharide, such as carboxymethylcellulose. Foams produced from these formulations are surprisingly versatile, remaining substantially stable despite a high or low concentration of fat. Furthermore, the components of these formulations can be modified (e.g. in quantity and/or type) to provide a foam with a desired texture, consistency, palatability, and/or bubble size.

Pectin is a polymer of a-galacturonic acid with a variable number of methyl ester groups. A representative chemical structure of pectin is presented in Formula (I) below: 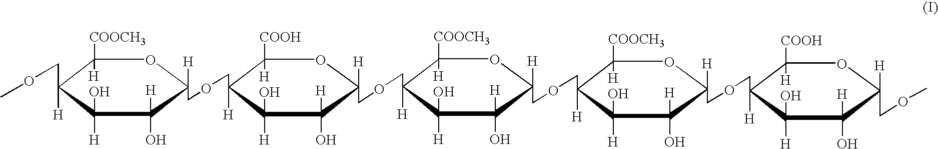
Pectin generally has chains of 300 to 1000 galacturonic acid units joined with 1α→4 linkages. In the example structure shown in formula (I), there are three methyl ester groups (—COOCH₃) for every two carboxyl groups (—COOH), and the corresponding Degree of Esterification (DE) is 60%.

Pectin as it is normally extracted typically has a DE higher than 50%. The extraction process may be modified and/or extracted pectin may undergo acid treatment, to produce pectin with DE lower than 50%. It is found in the Experimental Examples below that higher quality, more stable, more versatile foams were produced using such “low methyl ester”, “low methoxy”, or “LM” pectin.

Furthermore, in certain embodiments, amidated pectin is preferred over non-amidated pectin, and amidated pectin with DE lower than about 50% is preferred over amidated pectin with higher DE. Amidated pectin may be produced, for example, by treatment during manufacture with ammonia. Amidated pectin contains carboxyl groups (—COOH), methyl ester groups (—COOCH₃), and amidated groups (—CONH₂). The degree of amidation may vary. In certain embodiments, the pectin is from about 10% to about 40% amidated.

A traditional cappuccino is normally prepared with 1 or two shots of espresso in the bottom of a cup and filled with a steamed mixture of milk and milk foam. The milk is most commonly whole or nonfat milk and the foam typically comprises about 50% of the beverage volume. The foam of a well-prepared cappuccino will have a very fine bubble size and a thick and creamy texture, while the region which separates the foam from the liquid will be indistinct immediately after preparation. The attributes of this type of foam was used as a standard in evaluating the attributes of the foams in the Experimental Examples.

For embodiments in which a cappuccino foam is prepared, the texture and appearance of the foam should be as close as possible to that of a traditional cappuccino foam. It should be stable (maintaining at least 75% foam height after 5 minutes) when formulated with a range of fat contents. The foam should tolerate being spooned and having pastries dipped in it. It should be visually attractive, and the methods of preparation and dispensation should be convertible to restaurant or commercial scale. Finally, the beverage must have an appealing taste. Creamers with high viscosities (e.g. greater than 400 cps) tend to produce stable foams, but also tend towards a slimy mouth feel and unnatural appearance. In order to separate the stabilizing effects of high viscosities from less trivial stabilizing effects, the viscosities of the formulations in the Experimental Examples are measured.

### EXPERIMENTAL EXAMPLES

The compounds used in the experiments, and their manufacturers, are as follows: Low Methoxy Pectin: LM-104 AZ from CP Kelco (Nijmegen, The Netherlands); citrus pectin (non-amidated pectin): Genu pectin type X-914-02 from CP Kelco (Nijmegen, The Netherlands); carboxymethylcellulose (CMC): Cekol 30,000 P from CP Kelco (Nijmegen, The Netherlands); Xanthan Gum: from Bob's Red Mill (Milwaukie, Oreg.); Sodium Stearyol Lactylate: Paniplex SK from Archer Daniels Midland (Decatur, Ill.); Low molecular weight CMC: Type 7LXF 2.1%=40 cps from Hercules (Wilmington, Del.); Alginic Acid: A28309 from Sigma Aldrich (St. Louis, Mo.); Whey Protein Isolate (WPI): BiPro from Davisco Foods International (Eden Prairie, Minn.); Whey Protein Concentrate (WPC): Whey Protein Concentrate 80% from Davisco Foods International (Eden Prairie, Minn.); Pea Protein: Propulse from Parrheim Foods (Manitoba, Canada); carrageenan: Spectrum Chemicals (Wollaston, UK); potassium bicarbonate: Spectrum Chemicals (Wollaston, UK); Methyl Cellulose: 274429 from Sigma Aldrich (St. Louis, Mo.); Hydroxypropyl methyl cellulose (HPMC): 42323-8 from Sigma Aldrich (St. Louis, Mo.); Maltodextrin: Maltrin M100 from Grain Processing Corporation (Muscatine, Ind.); Corn Syrup Solids: Maltrin M250 from Grain Processing Corporation (Muscatine, Ind.); Egg Whites (Dried): Bob's Red Mill (Milwaukie, Oreg.); Sugar: Domino (Yonkers, N.Y.); Whole Milk: Garelick Farms (Franklin, Mass.); Skim Milk: Garelick Farms (Franklin, Mass.); Soy Milk: Vanilla Silk from Silk (Colorado); Half and Half: Garelick Farms (Franklin, Mass.); Guar Gum: 105008 from ICN Biomedicals (Aurora, Ohio); High Methoxy Pectin: Apple Pectin Powder from Solgar Vitamin and Herb (Leonia, N.J.); Sodium Dodecyl Sulfate: 23042-1000 from Acros (N.J.); Soy Protein: ISP-521_IDP from Cargill (Minneapolis, Minn.); Canola Oil: Wesson Canola Oil from ConAgra Foods (Omaha, Nebr.); and Instant Non Fat Dry Milk (Dry Milk): Nestle (Vevey, Switzerland); Nitrous oxide: N2O Specialties, Inc.; and chocolate syrup: Torani; almond syrup: Torani. The Low Methoxy Pectin has about 27% degree of esterification and about 20% amidation. The citrus pectin has about 9% esterification and is not amidated. The viscosity of the CMC is about 2294 cps at 1%. The viscosity of the Low molecular weight CMC is about 40 cps at 2%.

Dispensation/aeration of foam was performed in the experiments using a 1-L stainless steel whipped cream canister (Williams Sonoma), The dispensing mechanism includes a simple valve with no additional frothing or homogenizing components. Foams prepared in the experiments with this simple mechanism may also be prepared using a range of other simple and more complex aeration mechanisms, including, for example, disposable pressurized canisters and high-volume beverage dispensation systems.

### Example Set 1

### Aerated Unadulterated Whole Milk and Soy Milk—Unstable Foams

### Example 1.1

300 mL of whole milk at about ambient temperature was placed in the Williams Sonoma whipped cream canister charged with 8 g of nitrous oxide, and was shaken briefly. 100 mL of the aerated milk foam was dispensed into a 250 mL beaker and observed. The foam initially appeared attractive, with a fine bubble size and appetizing texture, but the bubbles quickly coalesced and became larger. After 2 minutes, there was no remaining foam.

### Example 1.2

300 mL of whole milk was heated to 70° C. and dispensed into a 250 mL beaker using the whipped cream canister charged with 8 g of nitrous oxide, shaken briefly. As in Example 1.1, the foam initially appeared attractive, with a fine bubble size and appetizing texture, but the bubbles quickly coalesced and became larger. After 2 minutes, the foam had collapsed to approximately 50% of its original volume and within 5 minutes, no foam remained.

### Example 1.3

300 mL of whole milk was heated to 70° C. and dispensed into 125 mL of hot coffee (from about 70° C. to about 80° C.) using the whipped cream canister charged with 8 g of nitrous oxide, shaken briefly. The foam initially had a fine bubble size and attractive texture, but collapsed to about ⅔ of its original height after 2 minutes and was about ¼ of its original height after 5 minutes.

### Example 1.4

300 mL of soy milk was placed in the William Sonoma whipped cream canister, charged with 8 g of nitrous oxide and shaken briefly. 100 mL of the foamed mixture was dispensed into a 250 mL beaker and observed. The foam initially appeared attractive with a fine bubble size and appetizing texture. After 2 minutes, there was no remaining foam.

### Example 1.5

300 mL of soy milk was heated to 70° C. and dispensed into a 250 mL beaker using the whipped cream canister charged with 8 g of nitrous oxide, shaken briefly. After 2 minutes, the foam had collapsed to approximately 50% of its original volume and within 5 minutes, no foam remained.

### Example 1.6

300 mL of soy milk was heated to 70° C. and dispensed into 125 mL of hot coffee (from about 70° C. to about 80° C.) using the whipped cream canister charged with 8 g of nitrous oxide, shaken briefly. After 2 minutes, the foam had collapsed to about ⅔ of its original height after 2 minutes and was about ¼ of its original height after 5 minutes.

### Example Set 2

### Formulations Using Various ECMs—Foams with Enhanced Stability

### Example 2.1

Pectin: The ingredients in Table 1 were mixed in a 500 mL plastic container, homogenized for 5 minutes in a shear mixer from Silverson, model L4RT-A, and allowed to stand for 20 minutes before viscosity was measured with a Brookfield viscometer.

TABLE 1
Formulation of Example 2.1

| Ingredient | | | |
|---|---|---|---|
| Type | Ingredient | Quantity | |
| base liquid | whole milk | 300 | mL |
| protein | egg whites | 3.6 | |
| other | sugar | 5 | g |
| polymer | maltodextrin | 5 | g |
| surfactant | sodium stearoyl | 1 | g |
| | lactylate | | |
| ECM | Low methoxy pectin | 3 | g |

The viscosity after 20 minutes was 30.4 cps. The mixture was placed in a 1L stainless steel whipped cream dispenser, charged with 8 g of nitrous oxide and shaken briefly. The mixture was dispensed into hot coffee (from about 70° C. to about 80° C.), stirred, and the foam height was measured over 5 minutes, with results indicated in Table 2.

TABLE 2
Foam of Example 2.1

| | Time | | |
|---|---|---|---|
| | Initial | 2 min. | 5 min. |
| Foam Height | 45 mm | 42 mm | 39 mm |

The foam was found to have an appetizing texture with fine bubbles which increased in size slightly over 5 minutes.

### Example 2.2

CMC: The ingredients in Table 3 were mixed in a 500 mL plastic container, homogenized for 5 minutes in a shear mixer from Silverson, model L4RT-A, and allowed to stand for 20 minutes before viscosity was measured with a Brookfield viscometer.

TABLE 3
Formulation of Example 2.2

| Ingredient | | | |
|---|---|---|---|
| Type | Ingredient | Quantity | |
| base liquid | whole milk | 300 | mL |
| protein | egg whites | 3.6 | |
| other | sugar | 5 | g |
| polymer | maltodextrin | 5 | g |
| surfactant | sodium stearoyl | 1 | g |
| | lactylate | | |
| ECM | Carboxy methyl | 3 | g |
| | cellulose | | |

The viscosity after 20 minutes was 93.6 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with excellent results as indicated in Table 4.

TABLE 4
Foam of Example 2.2

| | Time | | |
|---|---|---|---|
| | Initial | 2 min. | 5 min. |
| Foam Height | 48 mm | 45 mm | 42 mm |

### Example 2.3

Alginic acid: The ingredients in Table 5 were mixed in a 500 mL plastic container, homogenized for 5 minutes in a shear mixer from Silverson, model L4RT-A, and allowed to stand for 20 minutes.

TABLE 5
Formulation of Example 2.3

| Ingredient | | | |
|---|---|---|---|
| Type | Ingredient | Quantity | |
| base liquid | whole milk | 300 | mL |
| protein | egg whites | 3.6 | |
| other | sugar | 5 | g |
| other | maltodextrin | 5 | g |
| surfactant | sodium stearoyl | 1 | g |
| | lactylate | | |
| ECM | Alginic acid | 1.5 | g |
| other | Potassium | 100 | mg |
| | bicarbonate | | |

The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 6.

TABLE 6
Foam of Example 2.3

| | Time | | |
|---|---|---|---|
| | Initial | 2 min. | 5 min. |
| Foam Height | 38 mm | 35 mm | 33 mm |

### Example 2.4

Xanth gum: The ingredients in Table 7 were mixed in a 500 mL plastic container, homogenized for 5 minutes in a shear mixer from Silverson, model L4RT-A, and allowed to stand for 20 minutes before viscosity was measured with a Brookfield viscometer.

TABLE 7
Formulation of Example 2.4

| Ingredient | | | |
|---|---|---|---|
| Type | Ingredient | Quantity | |
| base liquid | whole milk | 300 | mL |
| protein | egg whites | 3.6 | g |
| other | sugar | 5 | g |
| polymer | maltodextrin | 5 | g |
| surfactant | sodium stearoyl | 1 | g |
| | lactylate | | |
| ECM | Xanth gum | 1 | g |

The viscosity after 20 minutes was 178 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 8.

TABLE 8
Foam of Example 2.4

| | Time | | |
|---|---|---|---|
| | Initial | 2 min. | 5 min. |
| Foam Height | 47 mm | 43 mm | 39 |

### Example Set 3

### Formulations Using Non-Preferred ECMs—Foams with Poorer Stability

### Example 3.1

HPMC: The ingredients in Table 9 were mixed in a 500 mL plastic container, homogenized for 5 minutes in a shear mixer from Silverson, model L4RT-A, and allowed to stand for 20 minutes before viscosity was measured with a Brookfield viscometer.

TABLE 9
Formulation of Example 3.1

| Ingredient | | | |
|---|---|---|---|
| Type | Ingredient | Quantity | |
| base liquid | whole milk | 300 | mL |
| protein | egg whites | 3.6 | |
| Non ionic | HPMC | 1.1 | g |
| polymer | | | |
| other | sugar | 5 | g |
| other | maltodextrin | 5 | g |
| surfactant | sodium stearoyl | 1 | g |
| | lactylate | | |

The viscosity after 20 minutes was 46 cps. The mixture was placed in a 1L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 10.

TABLE 10
Foam of Example 3.1

| | Time | | |
|---|---|---|---|
| | Initial | 2 min. | 5 min. |
| Foam Height | 42 mm | 28 mm | 8 mm |

### Example 3.2

Methyl Cellulose: The ingredients in Table 11 were mixed in a 500 mL plastic container, homogenized for 5 minutes in a shear mixer from Silverson, model L4RT-A, and allowed to stand for 20 minutes before viscosity was measured with a Brookfield viscometer.

TABLE 11
Formulation of Example 3.2

| Ingredient | | | |
|---|---|---|---|
| Type | Ingredient | Quantity | |
| base liquid | whole milk | 300 | mL |
| protein | egg whites | 3.6 | |
| non ionic | Methyl Cellulose | 1.5 | g |
| polymer | | | |
| other | sugar | 5 | g |
| other | maltodextrin | 5 | g |
| surfactant | sodium stearoyl | 1 | g |
| | lactylate | | |

The viscosity after 20 minutes was 103.2 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 12.

TABLE 12
Foam of Example 3.2

| | Time | | |
|---|---|---|---|
| | Initial | 2 min. | 5 min. |
| Foam Height | 44 mm | 35 mm | 12 mm |

### Example 3.3

High Methoxy Apple Pectin: The ingredients in Table 13 were mixed in a 500 mL plastic container, homogenized for 5 minutes in a shear mixer from Silverson, model L4RT-A, and allowed to stand for 20 minutes before viscosity was measured with a Brookfield viscometer.

TABLE 13
Formulation of Example 3.3

| Ingredient | | | |
|---|---|---|---|
| Type | Ingredient | Quantity | |
| base liquid | whole milk | 300 | mL |
| protein | egg whites | 3.6 | |
| polymer | maltodextrin | 5 | g |
| other | sugar | 5 | g |
| ECM | High methoxy pectin | 1.5 | g |

The viscosity after 20 minutes was 22 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 14.

TABLE 14
Foam of Example 3.3

| | Time | | |
|---|---|---|---|
| | Initial | 2 min. | 5 min. |
| Foam Height | 42 mm | 20 mm | 11 mm |

### Example 3.4

Guar Gum: The ingredients in Table 15 were mixed in a 500 mL plastic container, homogenized for 5 minutes in a shear mixer from Silverson, model L4RT-A, and allowed to stand for 20 minutes before viscosity was measured with a Brookfield viscometer.

TABLE 15
Formulation of Example 3.4

| Ingredient | | | |
|---|---|---|---|
| Type | Ingredient | Quantity | |
| base liquid | whole milk | 300 | mL |
| Surfactant | sodium stearoyl | 1 | g |
| | lactylate | | |
| Thickener | Guar Gum | 1 | g |
| Protein | Egg whites | 3.6 | g |
| Other | Sugar | 5 | g |
| polymer | Maltodextrin | 5 | g |

The viscosity after 20 minutes was 63.2 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 16.

TABLE 16
Foam of Example 3.4

| | Time | | |
|---|---|---|---|
| | Initial | 2 min. | 5 min. |
| Foam Height | 44 mm | 33 mm | 26 mm |

The foam had an acceptable texture, but was unstable.

### Example Set 4

### Formulations Demonstrating Improved Stability Using Combination of ECM, Polymer/Protein, and Surfactant—Formulations Missing One or More of These Components Are Not as Stable

### Example 4.1

ECM only: The ingredients in Table 17 were mixed in a 500 mL plastic container, homogenized for 5 minutes in a shear mixer from Silverson, model L4RT-A, and allowed to stand for 20 minutes before viscosity was measured with a Brookfield viscometer.

TABLE 17
Formulation of Example 4.1

| Ingredient | | | |
|---|---|---|---|
| Type | Ingredient | Quantity | |
| base liquid | whole milk | 300 | mL |
| ECM | CMC | 1 | g |

The viscosity after 20 minutes was 112.0 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 18.

TABLE 18
Foam of Example 4.1

| | Time | | |
|---|---|---|---|
| | Initial | 2 min. | 5 min. |
| Foam Height | 45 mm | 30 mm | 20 mm |

### Example 4.2

ECM and surfactant only: The ingredients in Table 19 were mixed in a 500 mL plastic container, homogenized for 5 minutes in a shear mixer from Silverson, model L4RT-A, and allowed to stand for 20 minutes before viscosity was measured with a Brookfield viscometer.

TABLE 19
Formulation of Example 4.2

| Ingredient | | | |
|---|---|---|---|
| Type | Ingredient | Quantity | |
| base liquid | whole milk | 300 | mL |
| ECM | CMC | 1 | g |
| surfactant | sodium stearoyl | 0.5 | g |
| | lactylate | | |

The viscosity after 20 minutes was 140.0 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 20.

TABLE 20
Foam of Example 4.2

| | Time | | |
|---|---|---|---|
| | Initial | 2 min. | 5 min. |
| Foam Height | 45 mm | 25 mm | 5 mm |

The foam collapsed quickly.

### Example 4.3

ECM and protein only: The ingredients in Table 21 were mixed in a 500 mL plastic container, homogenized for 5 minutes in a shear mixer from Silverson, model L4RT-A, and allowed to stand for 20 minutes before viscosity was measured with a Brookfield viscometer.

TABLE 21
Formulation of Example 4.3

| Ingredient | | | |
|---|---|---|---|
| Type | Ingredient | Quantity | |
| base liquid | whole milk | 300 | mL |
| protein | Egg whites | 3.6 | g |
| ECM | CMC | 1 | g |

The viscosity after 20 minutes was 123.2 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 22.

TABLE 22
Foam of Example 4.3

| | Time | | |
|---|---|---|---|
| | Initial | 2 min. | 5 min. |
| Foam Height | 50 mm | 45 mm | 37 mm |

### Example 4.4

ECM and edible water soluble polymer only: The ingredients in Table 23 were mixed in a 500 mL plastic container, homogenized for 5 minutes in a shear mixer from Silverson, model L4RT-A, and allowed to stand for 20 minutes before viscosity was measured with a Brookfield viscometer.

TABLE 23
Formulation of Example 4.4

| Ingredient | | | |
|---|---|---|---|
| Type | Ingredient | Quantity | |
| base liquid | whole milk | 300 | mL |
| polymer | maltodextrin | 5.0 | g |
| ECM | CMC | 1 | g |

The viscosity after 20 minutes was 109.6 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 24.

TABLE 24
Foam of Example 4.4

| | Time | | |
|---|---|---|---|
| | Initial | 2 min. | 5 min. |
| Foam Height | 47 mm | 40 mm | 32 mm |

### Example 4.5

ECM, edible water soluble polymer, and surfactant: The ingredients in Table 25 were mixed in a 500 mL plastic container, homogenized for 5 minutes in a shear mixer from Silverson, model L4RT-A, and allowed to stand for 20 minutes before viscosity was measured with a Brookfield viscometer.

TABLE 25
Formulation of Example 4.5

| Ingredient | | | |
|---|---|---|---|
| Type | Ingredient | Quantity | |
| base liquid | whole milk | 300 | mL |
| polymer | maltodextrin | 5.0 | g |
| Surfactant | Sodium stearoyl | 0.5 | g |
| | lactylate | | |
| ECM | CMC | 1 | g |

The viscosity after 20 minutes was 86.4 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 26.

TABLE 26
Foam of Example 4.5

| | Time | | |
|---|---|---|---|
| | Initial | 2 min. | 5 min. |
| Foam Height | 47 mm | 44 mm | 39 mm |

The foam was stable and appealing in texture and bubble size.

### Example 4.6

ECM, protein, and surfactant: The ingredients in Table 27 were mixed in a 500 mL plastic container, homogenized for 5 minutes in a shear mixer from Silverson, model L4RT-A, and allowed to stand for 20 minutes before viscosity was measured with a Brookfield viscometer.

TABLE 27
Formulation of Example 4.6

| Ingredient | | | |
|---|---|---|---|
| Type | Ingredient | Quantity | |
| base liquid | whole milk | 300 | mL |
| protein | Egg whites | 3.6 | g |
| Surfactant | Sodium stearoyl | 0.5 | g |
| | lactylate | | |
| ECM | CMC | 1 | g |

The viscosity after 20 minutes was 93.6 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 28.

TABLE 28
Foam of Example 4.6

| | Time | | |
|---|---|---|---|
| | Initial | 2 min. | 5 min. |
| Foam Height | 48 mm | 45 mm | 42 mm |

The foam was stable and appealing in texture and bubble size.

### Example Set 5

### Formulations Demonstrating Stability of Formulations from U.S. Patent Application No. US2004/0076730 (Wilkinson)—Poor Stability

### Example 5.1

The ingredients in Table 29 were mixed in a 500 mL plastic container, homogenized for 5 minutes in a shear mixer from Silverson, model L4RT-A, and allowed to stand for 20 minutes.

TABLE 29
Formulation of Example 5.1

| Ingredient | Quantity | |
|---|---|---|
| Nonfat (Skim) Milk | 300 | mL |
| whey protein concentrate | 7.35 | g |
| carrageenan | 100 | mg |

The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 30.

TABLE 30
Foam of Example 5.1

| | Time | | |
|---|---|---|---|
| | Initial | 2 min. | 5 min. |
| Foam Height | 52 mm | 10 mm | 0 mm |

### Example 5.2

The ingredients in Table 31 were mixed in a 500 mL plastic container, homogenized for 5 minutes in a shear mixer from Silverson, model L4RT-A, and allowed to stand for 20 minutes.

TABLE 31
Formulation of Example 5.2

| Ingredient | Quantity | |
|---|---|---|
| Whole Milk | 300 | mL |
| whey protein concentrate | 7.35 | g |
| carrageenan | 100 | mg |

The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 32.

TABLE 32
Foam of Example 5.2

| | Time | | |
|---|---|---|---|
| | Initial | 2 min. | 5 min. |
| Foam Height | 40 mm | 10 mm | 0 mm |

The foam initially had an attractive texture with a small bubble size, but collapsed quickly.

### Example Set 6

### Formulation Effectively Using Carbon Dioxide as Aerating Gas

### Example 6.1

CO₂: The ingredients in Table 33 were mixed in a 500 mL plastic container and stirred for 35 minutes before viscosity was measured with a Brookfield viscometer.

TABLE 33
Formulation of Example 6.1

| Ingredient | | | |
|---|---|---|---|
| Type | Ingredient | Quantity | |
| base liquid | whole milk | 300 | mL |
| protein | Egg whites | 3.6 | g |
| ECM | CMC | 700 | mg |
| surfactant | sodium stearoyl | 1 | g |
| | lactylate | | |
| ECM | low methoxy pectin | 2.0 | g |

The viscosity after stirring was 27 cps. The mixture was placed in a 1 L stainless steel whipped cream dispenser, charged with 8 g of carbon dioxide and shaken briefly. 100 mL of the foamed mixture was dispensed into a beaker at room temperature and observed. The foam maintained a volume of 100 mL for at least 15 minutes, with a small increased in bubble size. The mixture was dispensed into hot coffee (from about 70° C. to about 80° C.), stirred, and the foam stability was measured over 5 minutes, with results as indicated in Table 34.

TABLE 34
Foam of Example 6.1

| | Time | | |
|---|---|---|---|
| | Initial | 2 min. | 5 min. |
| Foam Height | 43 mm | 41 mm | 39 mm |

The foam was found to have an appetizing texture with fine bubbles which increased in size slightly over 5 minutes.

### Example Set 7

### Formulations Using Various Proteins

### Example 7.1

Whey Protein Isolate: The ingredients in Table 35 were mixed in a 500 mL plastic container, homogenized for 5 minutes in a shear mixer from Silverson, model L4RT-A, and allowed to stand for 20 minutes before viscosity was measured with a Brookfield viscometer.

TABLE 35
Formulation of Example 7.1

| Ingredient | | | |
|---|---|---|---|
| Type | Ingredient | Quantity | |
| base liquid | whole milk | 300 | mL |
| protein | WPI | 3.6 | g |
| ECM | CMC | 800 | mg |
| other | sugar | 5 | g |
| polymer | maltodextrin | 5 | g |
| surfactant | sodium stearoyl | 1 | g |
| | lactylate | | |

The viscosity after 20 minutes was 60.8 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 36.

TABLE 36
Foam of Example 7.1

| | Time | | |
|---|---|---|---|
| | Initial | 2 min. | 5 min. |
| Foam Height | 42 mm | 42 mm | 39 mm |

The foam was found to have an appetizing texture with fine bubbles which increased in size slightly over 5 minutes.

### Example 7.2

Whey Protein Concentrate: The ingredients in Table 37 were mixed in a 500 mL plastic container, homogenized for 5 minutes in a shear mixer from Silverson, model L4RT-A, and allowed to stand for 20 minutes before viscosity was measured with a Brookfield viscometer.

TABLE 37
Formulation of Example 7.2

| Ingredient | | | |
|---|---|---|---|
| Type | Ingredient | Quantity | |
| base liquid | whole milk | 300 | mL |
| protein | whey protein | 3.6 | g |
| | concentrate | | |
| ECM | CMC | 800 | mg |
| other | sugar | 5 | g |
| polymer | maltodextrin | 5 | g |
| surfactant | sodium stearoyl | 1 | g |
| | lactylate | | |
| ECM | Low methoxy pectin | 1.5 | g |

The viscosity after 20 minutes was 134 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 38.

TABLE 38
Foam of Example 7.2

| | Time | | |
|---|---|---|---|
| | Initial | 2 min. | 5 min. |
| Foam Height | 47 mm | 45 mm | 38 mm |

The foam was found to have an appetizing texture with fine bubbles which increased in size slightly over 5 minutes.

### Example 7.3

Pea Protein: The ingredients in Table 39 were mixed in a 500 mL plastic container, homogenized for 5 minutes in a shear mixer from Silverson, model L4RT-A, and allowed to stand for 20 minutes before viscosity was measured with a Brookfield viscometer.

TABLE 39
Formulation of Example 7.3

| Ingredient | | | |
|---|---|---|---|
| Type | Ingredient | Quantity | |
| base liquid | whole milk | 300 | mL |
| protein | Pea Protein | 3.6 | g |
| ECM | CMC | 800 | mg |
| other | sugar | 5 | g |
| polymer | maltodextrin | 5 | g |
| surfactant | sodium stearoyl | 1 | g |
| | lactylate | | |
| ECM | Low methoxy pectin | 1.5 | g |

The viscosity after 20 minutes was 117.6 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 40.

TABLE 40
Foam of Example 7.3

| | Time | | |
|---|---|---|---|
| | Initial | 2 min. | 5 min. |
| Foam Height | 43 mm | 43 mm | 41 mm |

The foam was found to have an appetizing texture with fine bubbles which increased in size slightly over 5 minutes.

### Example 7.4

Soy Protein: The ingredients in Table 41 were mixed in a 500 mL plastic container, homogenized for 5 minutes in a shear mixer from Silverson, model L4RT-A, and allowed to stand for 20 minutes before viscosity was measured with a Brookfield viscometer.

TABLE 41
Formulation of Example 7.4

| Ingredient | | | |
|---|---|---|---|
| Type | Ingredient | Quantity | |
| base liquid | whole milk | 300 | mL |
| protein | Soy Protein | 3.6 | g |
| ECM | CMC | 800 | mg |
| other | sugar | 5 | g |
| polymer | maltodextrin | 5 | g |
| surfactant | sodium stearoyl | 1 | g |
| | lactylate | | |
| ECM | Low methoxy pectin | 1.5 | g |

The viscosity after 20 minutes was 62 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 42.

TABLE 42
Foam of Example 7.5

| | Time | | |
|---|---|---|---|
| | Initial | 2 min. | 5 min. |
| Foam Height | 46 mm | 41 mm | 38 mm |

The foam was found to have an appetizing texture with fine bubbles which increased in size slightly over 5 minutes.

### Example Set 8

### Formulations Using Alternate Surfactant

### Example 8.1

Sodium Lauryl Sulfate (sodium dodecyl sulfate): The ingredients in Table 43 were mixed in a 500 mL plastic container, homogenized for 5 minutes in a shear mixer from Silverson, model L4RT-A, and allowed to stand for 20 minutes before viscosity was measured with a Brookfield viscometer.

TABLE 43
Formulation of Example 8.1

| Ingredient | | | |
|---|---|---|---|
| Type | Ingredient | Quantity | |
| base liquid | whole milk | 300 | mL |
| protein | WPC | 3.0 | g |
| ECM | CMC | 600 | mg |
| other | sugar | 5 | g |
| polymer | maltodextrin | 5 | g |
| ECM | Low methoxy pectin | 1.2 | g |
| surfactant | Sodium Dodecyl | 0.9 | g |
| | Sulfate | | |

The viscosity after 20 minutes was 53 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 44.

TABLE 44
Foam of Example 8.1

| | Time | | |
|---|---|---|---|
| | Initial | 2 min. | 5 min. |
| Foam Height | 46 mm | 46 mm | 44 mm |

The foam was found to have a smaller average bubble size than previous formulations using stearoyl lactylate as a surfactant, but had an unpleasant detergent-like taste.

### Example Set 9

### Formulations Using Various Base Liquids

### Example 9.1

Water with oil: The ingredients in Table 45 were mixed in a 500 mL plastic container, homogenized for 5 minutes in a shear mixer from Silverson, model L4RT-A, and allowed to stand for 20 minutes before viscosity was measured with a Brookfield viscometer.

TABLE 45
Formulation of Example 9.1

| Ingredient | | | |
|---|---|---|---|
| Type | Ingredient | Quantity | |
| base liquid | water | 300 | mL |
| protein | egg whites | 3.6 | g |
| ECM | CMC | 800 | mg |
| other | sugar | 5 | g |
| polymer | maltodextrin | 5 | g |
| surfactant | sodium stearoyl | 1 | g |
| | lactylate | | |
| ECM | Low methoxy pectin | 1.5 | g |
| fat | canola oil | 12 | g |

The viscosity after 20 minutes was 85 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 46.

TABLE 46
Foam of Example 9.1

| | Time | | |
|---|---|---|---|
| | Initial | 2 min. | 5 min. |
| Foam Height | 47 mm | 45 mm | 43 mm |

The foam was found to have a fine bubble size, with the vesicle size increasing slightly over 5 minutes. The foam was translucent and did not appear as appetizing as milk-based formulations.

### Example 9.2

Water with high concentration of oil: The ingredients in Table 47 were mixed in a 500 mL plastic container, homogenized for 5 minutes in a shear mixer from Silverson, model L4RT-A, and allowed to stand for 20 minutes before viscosity was measured with a Brookfield viscometer.

TABLE 47
Formulation of Example 9.2

| Ingredient | | | |
|---|---|---|---|
| Type | Ingredient | Quantity | |
| base liquid | water | 300 | mL |
| protein | egg whites | 3.6 | g |
| ECM | CMC | 800 | mg |
| other | sugar | 5 | g |
| polymer | maltodextrin | 5 | g |
| surfactant | sodium stearoyl | 1 | g |
| | lactylate | | |
| ECM | Low methoxy pectin | 1.5 | g |
| fat | canola oil | 36 | g |

The viscosity after 20 minutes was 115 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 48.

TABLE 48
Foam of Example 9.2

| | Time | | |
|---|---|---|---|
| | Initial | 2 min. | 5 min. |
| Foam Height | 47 mm | 44 mm | 44 mm |

### Example 9.3

Half and Half: The ingredients in Table 49 were mixed in a 500 mL plastic container, homogenized for 5 minutes in a shear mixer from Silverson, model L4RT-A, and allowed to stand for 20 minutes before viscosity was measured with a Brookfield viscometer.

TABLE 49
Formulation of Example 9.3

| Ingredient | | | |
|---|---|---|---|
| Type | Ingredient | Quantity | |
| base liquid | Half and Half | 300 | mL |
| protein | egg whites | 3.6 | g |
| ECM | CMC | 800 | mg |
| other | sugar | 5 | g |
| polymer | maltodextrin | 5 | g |
| surfactant | sodium stearoyl | 1 | g |
| | lactylate | | |
| ECM | Low methoxy pectin | 1.5 | g |

The viscosity after 20 minutes was 234.3 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 50.

TABLE 50
Foam of Example 9.3

| | Time | | |
|---|---|---|---|
| | Initial | 2 min. | 5 min. |
| Foam Height | 43 mm | 43 mm | 43 mm |

### Example 9.4

Soy milk: The ingredients in Table 51 were mixed in a 500 mL plastic container, homogenized for 5 minutes in a shear mixer from Silverson, model L4RT-A, and allowed to stand for 20 minutes before viscosity was measured with a Brookfield viscometer.

TABLE 51
Formulation of Example 9.4

| Ingredient | | | |
|---|---|---|---|
| Type | Ingredient | Quantity | |
| base liquid | Soy Milk | 300 | mL |
| protein | Egg Whites | 3.6 | g |
| ECM | CMC | 800 | mg |
| other | sugar | 5 | g |
| polymer | maltodextrin | 5 | g |
| surfactant | sodium stearoyl | 1 | g |
| | lactylate | | |
| ECM | Low methoxy pectin | 1.5 | g |

The viscosity after 20 minutes was 115 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 52.

TABLE 52
Foam of Example 9.4

| | Time | | |
|---|---|---|---|
| | Initial | 2 min. | 5 min. |
| Foam Height | 38 mm | 35 mm | 35 mm |

### Example Set 10

### Formulation with Additional Flavoring Agents

### Example 10.1

‘Almond Roca Mochacchino’: The ingredients in Table 53 were mixed in a 500 mL plastic container, homogenized for 5 minutes in a shear mixer from Silverson, model L4RT-A, and allowed to stand for 20 minutes before viscosity was measured with a Brookfield viscometer.

TABLE 53
Formulation of Example 10.1

| Ingredient | | | |
|---|---|---|---|
| Type | Ingredient | Quantity | |
| base liquid | whole milk | 300 | mL |
| Other | Chocolate syrup | 50 | g |
| Other | Almond syrup | 10 | g |
| Surfactant | sodium stearoyl | 1 | g |
| | lactylate | | |
| ECM | pectin | 1.75 | g |
| Protein | Egg whites | 3.6 | g |
| ECM | CMC | 700 | mg |

The viscosity after 20 minutes was 85 cps. The mixture was placed in a 1 L stainless steel whipped cream dispenser, charged with 8 g of nitrous oxide and shaken briefly. 100 mL of the foamed mixture was dispensed into a beaker at room temperature and observed. The foam maintained a volume of 100 mL for at least 15 minutes, with a small increase in bubble size. The mixture was dispensed into hot coffee (from about 70° C. to about 80° C.), stirred, and the foam stability was measured over 5 minutes, with results as indicated in Table 54.

TABLE 54
Foam of Example 10.1

| | Time | | |
|---|---|---|---|
| | Initial | 2 min. | 5 min. |
| Foam Height | 49 mm | 47 mm | 43 mm |

### Example Set 11

### Formulation Having High Viscosity and Poor Texture

### Example 11.1

Guar Gum, high viscosity: The ingredients in Table 55 were mixed in a 500 mL plastic container, homogenized for 5 minutes in a shear mixer from Silverson, model L4RT-A, and allowed to stand for 20 minutes before viscosity was measured with a Brookfield viscometer.

TABLE 55
Formulation of Example 11.1

| Ingredient | | | |
|---|---|---|---|
| Type | Ingredient | Quantity | |
| base liquid | whole milk | 300 | mL |
| Surfactant | sodium stearoyl | 1 | g |
| | lactylate | | |
| Thickener | Guar Gum | 2.7 | g |
| Protein | Egg whites | 3.6 | g |
| Other | Sugar | 5 | g |
| polymer | Maltodextrin | 5 | g |

The viscosity after 20 minutes was 745.4 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 56.

TABLE 56
Foam of Example 11.1

| | Time | | |
|---|---|---|---|
| | Initial | 2 min. | 5 min. |
| Foam Height | 50 mm | 50 mm | 50 mm |

The foam was very solid and thick, but not appetizing.

### Example Set 12

### Varying Molecular Weight of ECM

### Example 12.1

Low molecular weight ECM: The ingredients in Table 57 were mixed in a 500 mL plastic container, homogenized for 5 minutes in a shear mixer from Silverson, model L4RT-A, and allowed to stand for 20 minutes before viscosity was measured with a Brookfield viscometer.

TABLE 57
Formulation of Example 12.1

| Ingredient | | | |
|---|---|---|---|
| Type | Ingredient | Quantity | |
| base liquid | whole milk | 300 | mL |
| Surfactant | sodium stearoyl | 1 | g |
| | lactylate | | |
| ECM | Low MW CMC | 5.0 | g |
| Polymer | Maltodextrin | 5.0 | g |

The viscosity after 20 minutes was 93.5 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 58.

TABLE 58
Foam of Example 11.1

| | Time | | |
|---|---|---|---|
| | Initial | 2 min. | 5 min. |
| Foam Height | 50 mm | 43 mm | 38 mm |

The foam was stable with small bubbles.

### Example Set 13

### Formulations with Reduced Amount of Certain Ingredients

### Example 13.1

Lower amount of ECM: The ingredients in Table 59 were mixed in a 500 mL plastic container, homogenized for 5 minutes in a shear mixer from Silverson, model L4RT-A, and allowed to stand for 20 minutes before viscosity was measured with a Brookfield viscometer.

TABLE 59
Formulation of Example 13.1

| Ingredient | | | |
|---|---|---|---|
| Type | Ingredient | Quantity | |
| base liquid | whole milk | 300 | mL |
| Surfactant | sodium stearoyl | 1 | g |
| | lactylate | | |
| ECM | CMC | 0.75 | g |
| Protein | Egg Whites | 5.0 | g |

The viscosity after 20 minutes was 80.6 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 60.

TABLE 60
Foam of Example 13.1

| | Time | | |
|---|---|---|---|
| | Initial | 2 min. | 5 min. |
| Foam Height | 45 mm | 40 mm | 35 mm |

The foam was stable; however, the bubbles grew somewhat larger over 5 minutes.

### Example 13.2

Lower amount of Protein: The ingredients in Table 61 were mixed in a 500 mL plastic container, homogenized for 5 minutes in a shear mixer from Silverson, model L4RT-A, and allowed to stand for 20 minutes before viscosity was measured with a Brookfield viscometer.

TABLE 61
Formulation of Example 13.2

| Ingredient Type | Ingredient | Quantity | |
|---|---|---|---|
| base liquid | whole milk | 300 | mL |
| Surfactant | sodium stearoyl | 1 | g |
| | lactylate | | |
| ECM | CMC | 1.5 | g |
| Protein | Egg Whites | 0.5 | g |

The viscosity after 20 minutes was 314.6 cps. The mixture was placed in a 1 L stainless steel whipped cream dispenser, charged with 8 g of nitrous oxide and shaken briefly. The mixture was dispensed into hot coffee (from about 70° C. to about 80° C.), stirred, and the foam stability was measured over 5 minutes, with results as indicated in Table 62.

TABLE 62
Foam of Example 13.2

| Time | Initial | 2 min. | 5 min. |
|---|---|---|---|
| Foam Height | 46 mm | 43 mm | 43 mm |

The foam was stable with small bubbles.

### Example Set 14

### Formulations of Foam Having Whipped Cream Consistency, Including Low Fat and Fat-Free Foams

### Example 14.1

Whole Milk: The ingredients in Table 63 were mixed in a 500 mL plastic container, homogenized for 5 minutes in a shear mixer from Silverson, model L4RT-A, and allowed to stand in a refrigerator for about one hour.

TABLE 63
Formulation of Example 14.1

| Ingredient Type | Ingredient | Quantity | |
|---|---|---|---|
| base liquid | whole milk | 300 | mL |
| ECM | CMC | 1 | g |
| polymer | Corn syrup solids | 20 | g |
| ECM | Low methoxy pectin | 1 | g |
| surfactant | Sodium Stearoyl | 1 | g |
| | Lactylate | | |

The mixture was placed in a 1 L stainless steel whipped cream dispenser charged with 8 g of nitrous oxide, and shaken briefly. The mixture was dispensed and the foam stability was qualitatively assessed under ambient conditions.

The foam was found to have stability similar to whipped cream. The foam remained firm for approximately 100 seconds and then slowly collapsed but never liquefied.

### Example 14.2

Skim Milk: The ingredients in Table 64 were mixed in a 500 mL plastic container, homogenized for 5 minutes in a shear mixer from Silverson, model L4RT-A, and allowed to stand in a refrigerator for about one hour.

TABLE 64
Formulation of Example 14.2

| Ingredient Type | Ingredient | Quantity | |
|---|---|---|---|
| base liquid | skim milk | 300 | mL |
| ECM | CMC | 1 | g |
| polymer | Corn syrup solids | 20 | g |
| ECM | Low methoxy pectin | 1 | g |
| surfactant | Sodium Stearoyl | 1 | g |
| | Lactylate | | |

The mixture was placed in a 1 L stainless steel whipped cream dispenser charged with 8 g of nitrous oxide, and shaken briefly. The mixture was dispensed and the foam stability was qualitatively assessed under ambient conditions.

The foam was found to have stability similar to whipped cream. The foam remained firm for approximately 90 seconds and then slowly collapsed but never liquefied.

### Example 14.3

Soy Milk: The ingredients in Table 65 were mixed in a 500 mL plastic container, homogenized for 5 minutes in a shear mixer from Silverson, model L4RT-A, and allowed to stand in a refrigerator for about one hour.

TABLE 65
Formulation of Example 14.3

| Ingredient Type | Ingredient | Quantity | |
|---|---|---|---|
| base liquid | soy milk | 300 | mL |
| ECM | CMC | 1 | g |
| polymer | Corn syrup solids | 20 | g |
| ECM | Low methoxy pectin | 1.8 | g |
| surfactant | Sodium Stearoyl | 1 | g |
| | Lactylate | | |

The mixture was placed in a 1 L stainless steel whipped cream dispenser charged with 8 g of nitrous oxide, and shaken briefly. The mixture was dispensed and the foam stability was qualitatively assessed under ambient conditions.

The foam was found to have stability similar to whipped cream. The foam remained firm for approximately 80 seconds and then slowly collapsed but never liquefied.

### Example 14.4

Whole Milk, overly-thick formulation: The ingredients in Table 66 were mixed in a 500 mL plastic container, homogenized for 5 minutes in a shear mixer from Silverson, model L4RT-A, and allowed to stand in a refrigerator for about one hour.

TABLE 66
Formulation of Example 14.4

| Ingredient Type | Ingredient | Quantity | |
|---|---|---|---|
| base liquid | whole milk | 300 | mL |
| ECM | CMC | 2 | g |
| polymer | Corn syrup solids | 20 | g |
| ECM | Low methoxy pectin | 1 | g |
| surfactant | Sodium Stearoyl | 1 | g |
| | Lactylate | | |

The mixture was placed in a 1 L stainless steel whipped cream dispenser charged with 8 g of nitrous oxide, and shaken briefly. The mixture was dispensed and the foam stability was qualitatively assessed under ambient conditions.

The foam dispensed poorly and did not form a stable foam. It appeared that the gas did not dissolve into the liquid well, possibly due to the high viscosity of the formulation. The foam was not firm and liquefied quickly.

### Example 14.5

Whole Milk, overly-thick formulation: The ingredients in Table 67 were mixed in a 500 mL plastic container, homogenized for 5 minutes in a shear mixer from Silverson, model L4RT-A, and allowed to stand in a refrigerator for about one hour.

TABLE 67
Formulation of Example 14.5

| Ingredient Type | Ingredient | Quantity | |
|---|---|---|---|
| base liquid | whole milk | 300 | mL |
| ECM | CMC | 1 | g |
| polymer | Corn syrup solids | 20 | g |
| ECM | Low methoxy pectin | 2 | g |
| surfactant | Sodium Stearoyl | 1 | g |
| | Lactylate | | |

The mixture was placed in a 1 L stainless steel whipped cream dispenser charged with 8 g of nitrous oxide, and shaken briefly. The mixture was dispensed and the foam stability was qualitatively assessed under ambient conditions.

The foam dispensed poorly and did not form a stable foam. It appeared that the gas did not dissolve into the liquid well, possibly due to the high viscosity of the formulation. It is possible that the high viscosity is due to the high calcium sensitivity of the pectin, resulting in the formation of a gel-like structure. The foam was not firm and liquefied quickly.

### Example 14.6

Whole Milk, overly-thick formulation, with non-amidated pectin: The ingredients in Table 68 were mixed in a 500 mL plastic container, homogenized for 5 minutes in a shear mixer from Silverson, model L4RT-A, and allowed to stand in a refrigerator for about one hour.

TABLE 68
Formulation of Example 14.6

| Ingredient Type | Ingredient | Quantity | |
|---|---|---|---|
| base liquid | whole milk | 300 | mL |
| ECM | CMC | 1 | g |
| polymer | Corn syrup solids | 20 | g |
| ECM | Citrus pectin | 1 | g |
| surfactant | Sodium Stearoyl | 1 | g |
| | Lactylate | | |

The mixture was placed in a 1 L stainless steel whipped cream dispenser charged with 8 g of nitrous oxide, and shaken briefly. The mixture was dispensed and the foam stability was qualitatively assessed under ambient conditions.

The foam stability was unimpressive; the foam collapsed after 10 seconds. However, the foam was more stable than the foams in Experiments 14.4 and 14.5. It appeared that the gas did not dissolve into the liquid well, possibly due to the high viscosity of the solution. The viscosity was not as high as formulations in Examples 14.4 and 14.5, which contained too much high molecular weight CMC and/or amidated pectin.

### Example 14.7

Whole Milk, without pectin: The ingredients in Table 69 were mixed in a 500 mL plastic container, homogenized for 5 minutes in a shear mixer from Silverson, model L4RT-A, and allowed to stand in a refrigerator for about one hour.

TABLE 69
Formulation of Example 14.7

| Ingredient Type | Ingredient | Quantity | |
|---|---|---|---|
| base liquid | whole milk | 300 | mL |
| ECM | CMC | 1.5 | g |
| polymer | Corn syrup solids | 20 | g |
| surfactant | Sodium Stearoyl | 1 | g |
| | Lactylate | | |

The mixture was placed in a 1 L stainless steel whipped cream dispenser charged with 8 g of nitrous oxide, and shaken briefly. The mixture was dispensed and the foam stability was qualitatively assessed under ambient conditions.

The foam was only stable for approximately 5 seconds. The foam quickly collapsed and completely liquefied.

### Example 14.8

Whole Milk, with protein: The ingredients in Table 70 were mixed in a 500 mL plastic container, homogenized for 5 minutes in a shear mixer from Silverson, model L4RT-A, and allowed to stand in a refrigerator for about one hour.

TABLE 70
Formulation of Example 14.8

| Ingredient Type | Ingredient | Quantity | |
|---|---|---|---|
| base liquid | whole milk | 300 | mL |
| ECM | CMC | 1 | g |
| polymer | Corn syrup solids | 20 | g |
| ECM | Low methoxy pectin | 1 | g |
| Protein | Whey protein isolate | 1.5 | g |
| surfactant | Sodium Stearoyl | 1 | g |
| | Lactylate | | |

The mixture was placed in a 1 L stainless steel whipped cream dispenser charged with 8 g of nitrous oxide, and shaken briefly. The mixture was dispensed and the foam stability was qualitatively assessed under ambient conditions.

The foam stability was good but no better than comparable formulations without protein. The protein appeared to make the mixture harder to dissolve. The foam remained firm for approximately 100 seconds and then slowly collapsed but never liquefied.

### Example 14.9

Whole Milk, with low molecular weight CMC: The ingredients in Table 71 were mixed in a 500 mL plastic container, homogenized for 5 minutes in a shear mixer from Silverson, model L4RT-A, and allowed to stand in a refrigerator for about one hour.

TABLE 71
Formulation of Example 14.9

| Ingredient | | | |
|---|---|---|---|
| Type | Ingredient | Quantity | |
| base liquid | whole milk | 300 | mL |
| ECM | Low MW CMC | 1 | g |
| polymer | Corn syrup solids | 20 | g |
| ECM | Low methoxy pectin | 1 | g |
| surfactant | Sodium Stearoyl | 1 | g |
| | Lactylate | | |

The mixture was placed in a 1 L stainless steel whipped cream dispenser charged with 8 g of nitrous oxide, and shaken briefly. The mixture was dispensed and the foam stability was qualitatively assessed under ambient conditions.

The foam stability was good but not as good as the formulation in Experiment 14.1, having 1 g of high molecular weight CMC. The foam remained firm for approximately 60 seconds and then slowly collapsed, but never liquefied.

### Example 14.10

Whole Milk, with higher amount of low molecular weight CMC: The ingredients in Table 72 were mixed in a 500 mL plastic container, homogenized for 5 minutes in a shear mixer from Silverson, model L4RT-A, and allowed to stand in a refrigerator for about one hour.

TABLE 72
Formulation of Example 14.10

| Ingredient | | | |
|---|---|---|---|
| Type | Ingredient | Quantity | |
| base liquid | whole milk | 300 | mL |
| ECM | Low MW CMC | 3 | g |
| polymer | Corn syrup solids | 20 | g |
| ECM | Low methoxy pectin | 1 | g |
| surfactant | Sodium Stearoyl | 1 | g |
| | Lactylate | | |

The mixture was placed in a 1 L stainless steel whipped cream dispenser charged with 8 g of nitrous oxide, and shaken briefly. The mixture was dispensed and the foam stability was qualitatively assessed under ambient conditions.

The foam stability was comparable to the formulation of Example 14.1. The foam remained firm for approximately 100 seconds and then slowly collapsed but never liquefied.

### Example 14.11

Whole Milk, xanth gum: The ingredients in Table 73 were mixed in a 500 mL plastic container, homogenized for 5 minutes in a shear mixer from Silverson, model L4RT-A, and allowed to stand in a refrigerator for about one hour.

TABLE 73
Formulation of Example 14.11

| Ingredient | | | |
|---|---|---|---|
| Type | Ingredient | Quantity | |
| base liquid | whole milk | 300 | mL |
| ECM | Xanth gum | 1 | g |
| polymer | Corn syrup solids | 20 | g |
| ECM | Low methoxy pectin | 1 | g |
| surfactant | Sodium Stearoyl | 1 | g |
| | Lactylate | | |

The mixture was placed in a 1 L stainless steel whipped cream dispenser charged with 8 g of nitrous oxide, and shaken briefly. The mixture was dispensed and the foam stability was qualitatively assessed under ambient conditions.

The foam consistency and texture initially appeared good, but the foam collapsed in approximately 30 seconds, and completely liquefied.

### Example 14.12

Whole Milk, higher amount of xanth gum: The ingredients in Table 74 were mixed in a 500 mL plastic container, homogenized for 5 minutes in a shear mixer from Silverson, model L4RT-A, and allowed to stand in a refrigerator for about one hour.

TABLE 74
Formulation of Example 14.12

| Ingredient | | | |
|---|---|---|---|
| Type | Ingredient | Quantity | |
| base liquid | whole milk | 300 | mL |
| ECM | Xanth gum | 3 | g |
| polymer | Corn syrup solids | 20 | g |
| ECM | Low methoxy pectin | 1 | g |
| surfactant | Sodium Stearoyl | 1 | g |
| | Lactylate | | |

The mixture was placed in a 1 L stainless steel whipped cream dispenser charged with 8 g of nitrous oxide, and shaken briefly. The mixture was dispensed and the foam stability was qualitatively assessed under ambient conditions.

The foam dispensed poorly and did not form a stable foam. It appeared that the gas did not dissolve into the liquid well, possibly due to the high viscosity of the formulation. It is possible that the high viscosity is due to the high calcium sensitivity of the pectin, resulting in the formation of a gel-like structure.

### Example 14.13

Whole Milk, with dry milk solids: The ingredients in Table 75 were mixed in a 500 mL plastic container, homogenized for 5 minutes in a shear mixer from Silverson, model L4RT-A, and allowed to stand in a refrigerator for about one hour.

TABLE 75
Formulation of Example 14.13

| Ingredient | | | |
|---|---|---|---|
| Type | Ingredient | Quantity | |
| base liquid | whole milk | 300 | mL |
| ECM | CMC | 1 | g |
| polymer | Dry milk | 40 | g |
| ECM | Low methoxy pectin | 1 | g |
| surfactant | Sodium Stearoyl | 1 | g |
| | Lactylate | | |

The mixture was placed in a 1 L stainless steel whipped cream dispenser charged with 8 g of nitrous oxide, and shaken briefly. The mixture was dispensed and the foam stability was qualitatively assessed under ambient conditions.

The stability of the foam was good, but the foam had a grainy texture and taste, probably due to the high amount of solids. The foam had a similar stability to the examples with corn syrup solids, but the color was not as white and did not have as neutral a taste. The foam remained firm for approximately 95 seconds and then slowly collapsed but never liquefied.

### Example 14.14

Whole Milk, with xanth gum and no pectin: The ingredients in Table 76 were mixed in a 500 mL plastic container, homogenized for 5 minutes in a shear mixer from Silverson, model L4RT-A, and allowed to stand in a refrigerator for about one hour.

TABLE 76
Formulation of Example 14.14

| Ingredient | | | |
|---|---|---|---|
| Type | Ingredient | Quantity | |
| base liquid | whole milk | 300 | mL |
| ECM | Xanth gum | 2 | g |
| polymer | Corn syrup solids | 20 | g |
| surfactant | Sodium Stearoyl | 1 | g |
| | Lactylate | | |

The mixture was placed in a 1 L stainless steel whipped cream dispenser charged with 8 g of nitrous oxide, and shaken briefly. The mixture was dispensed and the foam stability was qualitatively assessed under ambient conditions.

The foam had poor stability. The foam quickly collapsed and completely liquefied in approximately 20 seconds.

Equivalents

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. An edible foam comprising:
a base liquid;
a surfactant;
a polysaccharide comprising units of at least one of the following:
(i) galacturonic acid;
(ii) galacturonic acid alkyl ester; and
(iii) galacturonic acid salt; and
a polymer capable of molecular interaction with said polysaccharide.

2. The foam of claim 1, wherein said polysaccharide comprises pectin.

3. The foam of claim 2, wherein said pectin has a degree of esterification less than about 50.

4. The foam of claim 2, wherein said pectin is amidated.

5. The foam of claim 2, wherein said pectin has an average molecular weight of at least about 50,000 Da.

6. The foam of claim 1, wherein said polymer comprises carboxymethylcellulose.

7. The foam of claim 1, wherein said polymer is edible and water soluble.

8. The foam of claim 1, wherein said polymer comprises maltodextrin.

9. The foam of claim 1, wherein said polymer comprises a protein.

10. The foam of claim 9, wherein said protein comprises at least one of the following: dairy protein, dairy whey, whey protein, whey protein concentrate, whey protein isolate, casein, egg protein, dried egg, egg white, dried egg white, egg albumin, egg albumen, ovalbumin, lactalbumin, lysozyme, soy protein, rice protein, pea protein, wheat protein, corn protein, vegetable protein, wheat gluten, gelatin, and serum albumin.

11. The foam of claim 1, wherein said polymer comprises at least one of the following: xanth gum, alginic acid, alignate, gum Arabic, acacia gum, gum tragacanth, chitin, beta-glucan, glycosaminoglycan, agar, carrageenan, guar gum, glucomannan, and any salt thereof.

12. The foam of claim 1, wherein said base liquid comprises at least one of the following: milk, nonfat milk, whole milk, partially reduced fat milk, low fat milk, skim milk, cream, heavy cream, bakers cream, half and half, goat milk, soy milk, rice milk, lactose free milk, nondairy creamer, yogurt, reconstituted dry milk, melted ice cream, ghee, and melted butter.

13. The foam of claim 1, wherein said base liquid comprises water.

14. The foam of claim 1, wherein said foam is aerated with at least one of the following: air, nitrogen, oxygen, carbon dioxide, helium, nitrous oxide, hydrogen, and dimethyl ether.

15. The foam of claim 1, wherein said surfactant comprises at least one of the following: an alkyl sulfonate, an alkyl lactylate, an alkyl acyl lactylate, a quaternary alkyl surfactant, a benzalkonium, a sorbitan ester, and any salt thereof.

16. The foam of claim 1, wherein said surfactant comprises sodium stearoyl lactylate.

17. The foam of claim 1, said foam comprising a polyvalent cation.

18. The foam of claim 17, wherein said polyvalent cation is Ca²⁺.

19. The foam of claim 1, wherein said foam contains from about 0.16 wt. % to about 0.33 wt. % said surfactant, from about 0.33 wt. % to about 2.0 wt. % said polysaccharide, and from about 0.33 wt. % to about 10.0 wt. % said polymer.

20. An edible foam comprising:
a base liquid;
a surfactant;
a polysaccharide having an average molecular weight of at least about 10,000 Da and having from about 0.25 to about 4 anionic groups per repeating monosaccharide unit; and
a polymer capable of molecular interaction with said polysaccharide.

21. The foam of claim 20, wherein said polysaccharide comprises at least one of the following monosaccharide units: tetrose, pentose, hexose, and heptose.

22. The foam of claim 20, said polysaccharide having from about 0.5 to about 3 anionic groups per repeating monosaccharide unit.

23. The foam of claim 20, said foam comprising at least one of the following: pectin having a degree of esterification less than about 50; amidated pectin, carboxymethylcellulose, xanth gum, alginic acid, alginate, gum Arabic, acacia gum, gum tragacanth, chitin, beta-glucan, glycosaminoglycan, agar, carrageenan, guar gum, glucomannan, and any salt thereof.

24. The foam of claim 20, wherein said polymer is edible and water soluble.

25. The foam of claim 20, wherein said polymer comprises maltodextrin.

26. The foam of claim 20, wherein said polymer comprises protein.

27. The foam of claim 20, wherein said surfactant comprises at least one of the following: an alkyl sulfonate, an alkyl lactylate, an alkyl acyl lactylate, a quaternary alkyl surfactant, a benzalkonium, a sorbitan ester, and any salt thereof.

28. The foam of claim 20, wherein said base liquid comprises milk, nonfat milk, whole milk, partially reduced fat milk, low fat milk, cream, heavy cream, bakers cream, half and half, goat milk, soy milk, rice milk, lactose free milk, nondairy creamer, yogurt, reconstituted dry milk, melted ice cream, ghee, and melted butter.

29. The foam of claim 20, said foam comprising a polyvalent cation.

30. The foam of claim 29, wherein said polyvalent cation is Ca²⁺.

31. The foam of claim 20, said polysaccharide having a molecular weight of at least about 50,000.

32. The foam of claim 20, wherein said foam maintains at least about 75% of its height after five minutes.

33. The foam of claim 20, wherein said foam maintains at least about 75% of its height after five minutes on a target liquid.

34. The foam of claim 33, wherein said target liquid comprises at least one of the following: coffee, espresso, cider, beer, alcohol, and carbonated water.

35. The foam of claim 33, wherein said foam maintains at least about 75% of its height despite mechanical agitation.

36. The foam of claim 33, wherein said target liquid is at least about 70° C.

37. The foam of claim 33, wherein said foam has a viscosity from about 1 cp to about 400 cp.

38. The foam of claim 33, wherein said foam has a viscosity from about 30 cp to about 150 cp.

39. The foam of claim 33, wherein said target liquid comprises a polyvalent cation.

40. The foam of claim 39, wherein said polyvalent cation is Ca²⁺.

41. The foam of claim 20, wherein said foam has a whipped cream consistency.

42. The foam of claim 41, wherein said foam maintains said whipped cream consistency without liquefying for at least about 60 seconds.

43. The foam of claim 41, wherein said foam has a viscosity from about 100 cp to about 400 cp.

44. The foam of claim 20, wherein said foam contains from about 0.16 wt. % to about 0.33 wt. % said surfactant, from about 0.33 wt. % to about 2.0 wt. % said polysaccharide, and from about 0.33 wt. % to about 10.0 wt. % said polymer.

45. The foam of claim 20, dispensed from a pressurized container.

46. The foam of claim 20, dispensed from a restaurant beverage dispensation system.

47. A liquid that is capable of forming an edible foam upon aeration, said liquid comprising:
(a) at least one of the following: milk, nonfat milk, whole milk, partially reduced fat milk, low fat milk, cream, heavy cream, bakers cream, half and half, goat milk, soy milk, rice milk, lactose free milk, nondairy creamer, yogurt, reconstituted dry milk, melted ice cream, ghee, and melted butter;
(b) a surfactant;
(c) a polysaccharide comprising units of at least one of the following:
(i) galacturonic acid;
(ii) galacturonic acid alkyl ester; and
(iii) galacturonic acid salt; and
(d) carboxymethylcellulose.

48. The liquid of claim 47, said liquid comprising an amidated pectin with a degree of esterification less than about 50, said pectin comprising said polysaccharide.

49. The liquid of claim 47, wherein said liquid is capable of forming an edible foam upon aeration, wherein said foam maintains at least about 75% of its height after five minutes.
